(19) United States
(12) Patent Application Publication
(10) Pub. No.: US 2014/0342152 A1
(43) Pub. Date: Nov. 20, 2014

(54) REMOVABLE WATER-DISPERSIBLE ACRYLIC PRESSURE-SENSITIVE ADHESIVE COMPOSITION, AND PRESSURE-SENSITIVE ADHESIVE SHEET

(71) Applicant: NITTO DENKO CORPORATION, Ibaraki-shi, Osaka (JP)

(72) Inventors: Tatsumi Amano, Osaka (JP); Yu Morimoto, Osaka (JP); Kazuma Mitsui, Osaka (JP); Kousuke Yonezaki, Osaka (JP); Kyoko Takashima, Osaka (JP)

(73) Assignee: NITTO DENKO CORPORATION, Ibaraki-shi, Osaka (JP)

(21) Appl. No.: 14/352,533

(22) PCT Filed: Oct. 12, 2012
(86) PCT No.: PCT/JP2012/076448

§ 371 Date: Apr. 17, 2014

(30) Foreign Application Priority Data
Oct. 19, 2011 (JP) 2011-230077
Oct. 19, 2011 (JP) 2011-230101
Oct. 9, 2012 (JP) 2011-224519

(51) Int. Cl. C09J 133/08

(52) U.S. Cl. CPC C09J 133/08
USPC 428/355 AC; 428/522; 252/500; 252/519.34

(57) ABSTRACT

An object of the invention to provide a water-dispersible acrylic pressure-sensitive adhesive composition capable of forming a pressure-sensitive adhesive layer that can prevent static build-up on adherends when peeled off (antistatic properties) and is superior not only in removability and the ability to prevent an increase in peel strength (adhesive strength) over time but also in less-staining properties on adherends and, especially, the ability to prevent white staining on adherends in a high-humidity environment (the ability to prevent white staining). The invention is directed to a removable water-dispersible acrylic pressure-sensitive adhesive composition, including: an acrylic emulsion polymer including units derived from raw material monomers including (i) 70 to 99.5% by weight of an alkyl(meth)acrylate and (ii) 0.5 to 10% by weight of a carboxyl group-containing unsaturated monomer; a non-water-soluble crosslinking agent; and an ionic compound.

### TECHNICAL FIELD

The invention relates to a water-dispersible acrylic pressure-sensitive adhesive composition capable of forming a removable pressure-sensitive adhesive layer. Specifically, the invention relates to a removable water-dispersible acrylic pressure-sensitive adhesive composition capable of forming a pressure-sensitive adhesive layer superior not only in antistatic properties and removability but also in less-staining properties on adherends and the ability to prevent an increase in peel strength (adhesive strength) over time. The invention also relates to a pressure-sensitive adhesive sheet having a pressure-sensitive adhesive layer made from the pressure-sensitive adhesive composition.

### TECHNICAL FIELD

In the process of manufacturing or processing an optical member (optical material) such as an optical film for use as a polarizing plate, a retardation plate, or an anti-reflection plate, a surface protecting film is attached to the surface of the optical member to prevent scratching, staining, or cracking of the surface or to improve cutting workability (see Patent Documents 1 and 2). Such a surface protecting film used is generally a removable pressure-sensitive adhesive sheet including a plastic film substrate and a removable pressure-sensitive adhesive layer provided on the surface of the substrate.

Traditionally, solvent-type acrylic pressure-sensitive adhesives are used in such surface protecting film applications (see Patent Documents 1 and 2). However, such solvent-type acrylic pressure-sensitive adhesives, which contain an organic solvent, are being replaced by water-dispersible acrylic pressure-sensitive adhesives in view of working environment during application (see Patent Documents 3 to 5).

While attached to optical members, such surface protecting films are required to have sufficient adhesion. In addition, such surface protecting films are required to have good peelability (removability) because they are peeled off after use in optical member-manufacturing processes or other processes. Such surface protecting films are required not only to have relatively low peel strength (light peelability) for good removability but also to have the property that its peel strength (adhesive strength) will not increase over time after it is attached to an adherend such as an optical member (the ability to prevent an increase in peel strength (adhesive strength)).

In general, surface protecting films and optical members are made of plastic materials and therefore are highly electrically insulating and can generate static electricity when they are rubbed or peeled off. Therefore, static electricity can be generated when a surface protecting film is peeled off from an optical member such as a polarizing plate, and if a voltage is applied to a liquid crystal in a state where the generated static electricity still remains, the orientation of the liquid crystal molecule may degrade, or defects may occur in the panel.

The presence of static electricity can also create a risk of attracting dust or dirt or a risk of reducing workability. To solve this problem, therefore, surface protecting films undergo various antistatic treatments.

To suppress such electrostatic build-up, an antistatic method is disclosed which includes adding a low-molecular-weight surfactant to an adhesive and transferring the surfactant from the pressure-sensitive adhesive to the object to be protected (see, for example, Patent Document 6). In this technique, however, the added low-molecular-weight surfactant can easily bleed to the surface of the pressure-sensitive adhesive, and if this technique is applied to a surface protecting film, there can be a risk of staining on an adherend (the object to be protected).

Surface protecting film applications (especially, applications for protecting optical member surfaces) etc. also have the following problem. When a pressure-sensitive adhesive sheet is peeled off from the adherend (such as an optical member), the pressure-sensitive adhesive can remain on the surface of the adherend (to cause what is called an “adhesive residue”), or some components in the pressure-sensitive adhesive layer can transfer onto the surface of the adherend, so that staining can occur on the surface of the adherend, which may have an adverse effect on the optical properties of the optical member. Thus, pressure-sensitive adhesives or pressure-sensitive adhesive layers are strongly required to have less-staining properties on adherends.

### PRIOR ART DOCUMENTS

### Patent Documents

Patent Document 1: JP-A-11-961

Patent Document 2: JP-A-2001-64607

Patent Document 3: JP-A-2001-131512

Patent Document 4: JP-A-2003-27026

Patent Document 5: Japanese Patent No. 3810490

Patent Document 6: JP-A-09-165460

### SUMMARY OF THE INVENTION

### Problems to be Solved by the Invention

However, as mentioned above, none of the conventional techniques can solve the problems in a well-balanced manner. In electronics related technical fields where static build-up or staining is a particularly serious problem, the conventional techniques hardly address demands for further improvement of surface protecting films with antistatic properties and other properties. There is no water-dispersible acrylic pressure-sensitive adhesive with good removability available at present.

It is therefore an object of the invention to provide a removable water-dispersible acrylic pressure-sensitive adhesive composition capable of forming a pressure-sensitive adhesive layer that can prevent static build-up on adherends when peeled off (antistatic properties) and is superior not only in removability and the ability to prevent an increase in peel strength (adhesive strength) over time but also in less-staining properties on adherends and, especially, the ability to prevent white staining on adherends in a high-humidity environment (the ability to prevent white staining). It is another object of the invention to provide a pressure-sensitive adhesive sheet having a pressure-sensitive adhesive layer made from such a pressure-sensitive adhesive composition.

### Means for Solving the Problems

As a result of earnest study to achieve the objects, the inventors have completed the invention based on findings that a removable water-dispersible acrylic pressure-sensitive adhesive composition obtained using, as components, a specific acrylic emulsion polymer obtained from raw material monomers with a specific composition, a non-water-soluble crosslinking agent, and an ionic compound can form a pressure-sensitive adhesive layer superior in antistatic properties, removability, the ability to prevent an increase in peel strength (adhesive strength), and less-staining properties.

That is, the invention is directed to a removable water-dispersible acrylic pressure-sensitive adhesive composition, including: an acrylic emulsion polymer including units derived from raw material monomers including (i) 70 to 99.5% by weight of an alkyl(meth)acrylate and (ii) 0.5 to 10% by weight of a carboxyl group-containing unsaturated monomer; a non-water-soluble crosslinking agent; and an ionic compound.

In the invention, the ionic compound is preferably an ionic liquid and/or an alkali metal salt.

In the removable water-dispersible acrylic pressure-sensitive adhesive composition of the invention, the ionic liquid preferably contains at least one cation selected from the group consisting of cations represented by formulae (A) to (E):

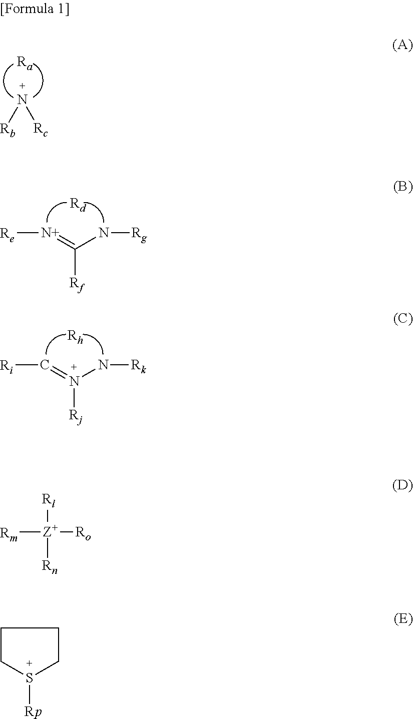

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

In the removable water-dispersible acrylic pressure-sensitive adhesive composition of the invention, the ionic liquid preferably contains a cation of at least one selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type.

In the removable water-dispersible acrylic pressure-sensitive adhesive composition of the invention, the ionic liquid preferably contains at least one cation selected from the group consisting of cations represented by formulae (a) to (d):

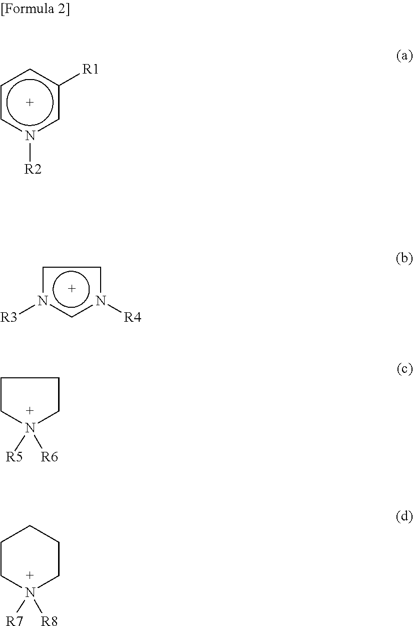

In formula (a), R₁ represents hydrogen or a hydrocarbon group of 1 to 3 carbon atoms, and R₂ represents hydrogen or a hydrocarbon group of 1 to 7 carbon atoms.

In formula (b), R₃ represents hydrogen or a hydrocarbon group of 1 to 3 carbon atoms, and R₄ represents hydrogen or a hydrocarbon group of 1 to 7 carbon atoms.

In formula (c), R₅ represents hydrogen or a hydrocarbon group of 1 to 3 carbon atoms, and R₆ represents hydrogen or a hydrocarbon group of 1 to 7 carbon atoms.

In formula (d), R₇ represents hydrogen or a hydrocarbon group of 1 to 3 carbon atoms, and R₈ represents hydrogen or a hydrocarbon group of 1 to 7 carbon atoms.

The removable water-dispersible acrylic pressure-sensitive adhesive composition of the invention preferably contains 4.9 parts by weight or less of the ionic liquid based on 100 parts by weight (on a solid basis) of the acrylic emulsion polymer.

In the removable water-dispersible acrylic pressure-sensitive adhesive composition of the invention, the alkali metal salt preferably has a fluorine-containing anion.

In the removable water-dispersible acrylic pressure-sensitive adhesive composition of the invention, the alkali metal salt is preferably a lithium salt.

The removable water-dispersible acrylic pressure-sensitive adhesive composition of the invention preferably contains 3 parts by weight or less of the alkali metal salt based on 100 parts by weight of the solid of the acrylic emulsion polymer.

In the removable water-dispersible acrylic pressure-sensitive adhesive composition of the invention, the acrylic emulsion polymer is preferably a product of polymerization with a reactive emulsifier containing a radically-polymerizable functional group in its molecule.

In the removable water-dispersible acrylic pressure-sensitive adhesive composition of the invention, the non-water-soluble crosslinking agent preferably has 0.2 to 1.3 moles of a functional group capable of reacting with a carboxyl group per mole of the carboxyl group of the carboxyl group-containing unsaturated monomer (ii).

The invention is also directed to a pressure-sensitive adhesive sheet, which preferably includes a substrate and a pressure-sensitive adhesive layer formed on at least one side of the substrate and made from the removable water-dispersible acrylic pressure-sensitive adhesive composition.

The pressure-sensitive adhesive sheet of the invention is preferably a surface protecting film for use on an optical member.

The invention is also directed to an optical member which preferably includes the pressure-sensitive adhesive sheet as a bonded component.

### Effect of the Invention

The removable water-dispersible acrylic pressure-sensitive adhesive composition of the invention, which contains a specific acrylic emulsion polymer, a non-water-soluble crosslinking agent, and an ionic compound, can be used for removable applications and can form a pressure-sensitive adhesive layer (pressure-sensitive adhesive sheet) having a good level of antistatic properties, adhesion, and removability. In particular, such a pressure-sensitive adhesive layer (pressure-sensitive adhesive sheet) made from the pressure-sensitive adhesive composition is superior in the ability to prevent an increase in peel strength (adhesive strength) to an adherend over time. Such a pressure-sensitive adhesive layer (pressure-sensitive adhesive sheet) made from the pressure-sensitive adhesive composition is also superior in less-staining properties, especially, the ability to prevent white staining during storage in a high-humidity environment. Thus, the water-dispersible acrylic pressure-sensitive adhesive composition of the invention is particularly useful in applications to protect the surface of optical films.

### BRIEF DESCRIPTION OF THE DRAWING

FIG. 1 is a schematic diagram of an electrical potential measuring unit.

### MODE FOR CARRYING OUT THE INVENTION

The removable water-dispersible acrylic pressure-sensitive adhesive composition of the invention (also referred to as the “pressure-sensitive adhesive composition”) includes, as essential components, an acrylic emulsion polymer including units derived from raw material monomers including (i) 70 to 99.5% by weight of an alkyl(meth)acrylate and (ii) 0.5 to 10% by weight of a carboxyl group-containing unsaturated monomer; a non-water-soluble crosslinking agent; and an ionic compound. As regards the pressure-sensitive adhesive composition of the invention, the term “water-dispersible” refers to the ability to be dispersed in an aqueous medium, in other words, means that the pressure-sensitive adhesive composition is dispersible in an aqueous medium. The aqueous medium is a medium (dispersion medium) containing water as an essential component. The aqueous medium may be water alone or a mixture of water and a water-soluble organic solvent. The pressure-sensitive adhesive composition of the invention may also be a dispersion containing the aqueous medium.

### [Acrylic Emulsion Polymer]

The acrylic emulsion polymer is a polymer made from raw material monomers including (i) 70 to 99.5% by weight of an alkyl(meth)acrylate and (ii) 0.5 to 10% by weight of a carboxyl group-containing unsaturated monomer. One acrylic emulsion polymer may be used alone, or two or more acrylic emulsion polymers may be used in combination. As used herein, the term “(meth)acrylate” refers to acrylate and/or methacrylate.

The alkyl(meth)acrylate (i), which is used as a principal monomer, plays a role to produce basic properties for the pressure-sensitive adhesive (or pressure-sensitive adhesive layer), such as adhesion and removability. In particular, alkyl acrylates tend to impart flexibility to the polymer used to from the pressure-sensitive adhesive layer and tend to produce the effect of allowing the pressure-sensitive adhesive layer to have tackiness and adhesive properties. Alkyl methacrylates tend to impart hardness to the polymer used to form the pressure-sensitive adhesive layer and tend to produce the effect of controlling the removability of the pressure-sensitive adhesive layer. The alkyl(meth)acrylate (i) may be, but not limited to, an alkyl(meth)acrylate having a linear, branched, or cyclic alkyl group of 2 to 16 carbon atoms (more preferably 2 to 10 carbon atoms, even more preferably 4 to 8 carbon atoms).

For example, the alkyl acrylate is preferably an alkyl acrylate having an alkyl group of 2 to 14 carbon atoms (more preferably 4 to 9 carbon atoms), examples of which include n-butyl acrylate, isobutyl acrylate, sec-butyl acrylate, isoamyl acrylate, hexyl acrylate, heptyl acrylate, octyl acrylate, 2-ethylhexyl acrylate, isooctyl acrylate, nonyl acrylate, isononyl acrylate, and other alkyl acrylates having a linear or branched alkyl group. In particular, 2-ethylhexyl acrylate is preferred.

For example, the alkyl methacrylate is preferably an alkyl methacrylate having an alkyl group of 2 to 16 carbon atoms (more preferably 2 to 10 carbon atoms), examples of which include ethyl methacrylate, propyl methacrylate, isopropyl methacrylate, n-butyl methacrylate, isobutyl methacrylate, sec-butyl methacrylate, tert-butyl methacrylate, and other alkyl methacrylates having a linear or branched alkyl group; and cyclic alkyl methacrylates such as cyclohexylmethacrylate, bornyl methacrylate, and isobornyl methacrylate.

These alkyl(meth)acrylate(s) (i) may be appropriately selected depending on the desired adhesive properties and other properties and may be used singly or in combination of two or more.

The content of the alkyl(meth)acrylate(s) (i) is from 70 to 99.5% by weight, preferably from 85 to 98% by weight, more preferably from 87 to 96% by weight, based on the total amount of the raw material monomers (all the raw material monomers (100% by weight)) used to form the acrylic emulsion polymer according to the invention. An alkyl(meth)acrylate content of 70% by weight or more is preferable in that the pressure-sensitive adhesive layer can have improved adhesion or removability. On the other hand, if the alkyl(meth)acrylate content is more than 99.5% by weight, the carboxyl group-containing unsaturated monomer (ii) content will be relatively low, so that the pressure-sensitive adhesive composition can form a pressure-sensitive adhesive layer with an undesirable appearance. When two or more alkyl(meth)acrylates (i) are used, the total content (total amount) of all the alkyl(meth)acrylates (i) should fall within the range.

The carboxyl group-containing unsaturated monomer (ii) can form a protective layer at the surface of emulsion particles including the acrylic emulsion polymer according to the invention and can function to prevent shear failure of the particles. This effect can be further improved by neutralizing the carboxyl group with a base. The stability of the particles against shear failure is more generally called mechanical stability. When used in combination with one or more non-water-soluble crosslinking agents reactive with the carboxyl group, the carboxyl group-containing unsaturated monomer can also act as a crosslink point at a stage where the pressure-sensitive adhesive layer is formed through removal of water. The carboxyl group-containing unsaturated monomer can also improve the tackiness (anchoring properties) to a substrate through the non-water-soluble crosslinking agent. Examples of such a carboxyl group-containing unsaturated monomer (ii) include (meth)acrylic acid (acrylic acid and/or methacrylic acid), itaconic acid, maleic acid, fumaric acid, crotonic acid, carboxyethyl acrylate, and carboxypentyl acrylate. The “carboxyl group-containing unsaturated monomer” (ii) is also intended to include acid anhydride group-containing unsaturated monomers such as maleic anhydride and itaconic anhydride. In particular, acrylic acid is preferred because it can have a relatively high concentration at the particle surface and can easily form a protective layer with a higher density.

The content of the carboxyl group-containing unsaturated monomer (ii) is from 0.5 to 10% by weight, preferably from 1 to 5% by weight, more preferably from 2 to 4% by weight, based on the total amount of the raw material monomers (all the raw material monomers (100% by weight)) used to form the acrylic emulsion polymer according to the invention. When the content is 10% by weight or less, an increase in the interaction between a pressure-sensitive adhesive layer and functional groups present on the surface of an adherend (the object to be protected) such as a polarizing plate can be suppressed after the pressure-sensitive adhesive layer is formed, so that an increase in peel strength (adhesive strength) over time can be suppressed and peelability can be improved, which is preferred. If the content is more than 10% by weight, the carboxyl group-containing unsaturated monomer (ii) (such as acrylic acid), which is generally soluble in water, may be polymerized in water to cause thickening (an increase in viscosity). It is conceivable that if a large number of carboxyl groups are present in the skeleton of the acrylic emulsion polymer, the carboxyl groups can interact with the ionic compound (such as an ionic liquid or an alkali metal salt), which is added as an antistatic agent, so that ion conduction can be hindered and antistatic performance for the adherend may fail to be obtained, which is not preferred. On the other hand, when the content is 0.5% by weight or more, the emulsion particles can have higher mechanical stability, which is preferred. In this case, tackiness (anchoring properties) between the pressure-sensitive adhesive layer and the substrate can also increase, so that adhesive residues can be suppressed, which is preferred.

Other monomers for imparting a specific function may also be used in combination with the raw material onomers (the alkyl(meth)acrylate (i) and the carboxyl group-containing unsaturated monomer (ii)) to form the acrylic emulsion polymer according to the invention. Examples of such monomers include methyl methacrylate, vinyl acetate, diethylacrylamide, etc., which may be used to reduce appearance defects. When any of these monomers are used, the emulsion particles can have higher stability, so that a gel (aggregate) can be reduced. The use of any of these monomers also makes it possible to increase the affinity for the hydrophobic non-water-soluble crosslinking agent, so that the emulsion particles can have higher dispersibility and poor dispersion-induced dents on the pressure-sensitive adhesive layer can be reduced. An epoxy group-containing monomer such as glycidyl(meth)acrylate or a polyfunctional monomer such as trimethylolpropane tri(meth)acrylate or divinylbenzene may also be used for the purposes of crosslinking the interior of the emulsion particles and increasing the cohesive strength. These monomers are each preferably mixed (added) at a content of less than 5% by weight. This content (amount) is based on the total amount of the raw material monomers (all the raw material monomers (100% by weight)) used to form the acrylic emulsion polymer according to the invention.

To further reduce white staining, it is preferable to reduce the amount (content) of a hydroxyl group-containing unsaturated monomer such as 2-hydroxyethyl acrylate or 2-hydroxypropyl acrylate as one of the other monomers mentioned above. Specifically, the content of a hydroxyl group-containing unsaturated monomer in the raw material monomers (all the raw material monomers (100% by weight)) used to form the acrylic emulsion polymer according to the invention is preferably less than 1% by weight, more preferably less than 0.1% by weight, even more preferably substantially 0% by weight (typically, less than 0.05% by weight). In some cases, however, it is necessary to introduce a crosslink point, such as crosslink between a hydroxyl group and an isocyanate group or metal crosslink. In such cases, a hydroxyl group-containing unsaturated monomer may be added (used) in an amount of about 0.01 to about 10% by weight.

In the invention, the acrylic emulsion polymer can be obtained by subjecting the above raw material monomers (monomer mixture) to emulsion polymerization in the presence of an emulsifier and a polymerization initiator.

An emulsifier may be used in the emulsion polymerization for producing the acrylic emulsion polymer according to the invention. The emulsifier is preferably a reactive emulsifier having a radically-polymerizable functional group introduced in the molecule (radically-polymerizable functional group-containing reactive emulsifier). Such emulsifiers may be used alone or in combination of two or more.

### [Reactive Emulsifier]

The radically-polymerizable functional group-containing reactive emulsifier (hereinafter, referred to as the “reactive emulsifier”) has at least one radically-polymerizable functional group in the molecule (per molecule). The reactive emulsifier may be, but not limited to, one or more selected from a variety of reactive emulsifiers having a radically-polymerizable functional group such as a vinyl group, a propenyl group, an isopropenyl group, a vinyl ether group (vinyloxy group), or an allyl ether group (allyloxy group). The reactive emulsifier is preferably used because the emulsifier can be incorporated into the polymer so that staining caused by the emulsifier can be reduced.

For example, the reactive emulsifier may have a structure obtained by introducing a radially-polymerizable functional group (radially reactive group) such as a propenyl group or an allyl ether group into a nonionic-anionic emulsifier (a nonionic hydrophilic group-containing anionic emulsifier) such as sodium polyoxyethylene alkyl ether sulfate, ammonium polyoxyethylene alkyl phenyl ether sulfate, sodium polyoxyethylene alkyl phenyl ether sulfate, or sodium polyoxyethylene alkyl sulfosuccinate (or may correspond to such a structure). Hereinafter, the reactive emulsifier having a structure obtained by introducing a radically-polymerizable functional group into an anionic emulsifier will be called the “anionic reactive emulsifier.” The reactive emulsifier having a structure obtained by introducing a radically-polymerizable functional group into a nonionic-anionic emulsifier will be called the “nonionic-anionic reactive emulsifier.”

Particularly when the anionic reactive emulsifier (especially, the nonionic-anionic reactive emulsifier) is used, the emulsifier can improve the less-staining properties by being incorporated into the polymer. Also particularly when the non-water-soluble crosslinking agent according to the invention is a polyfunctional epoxy crosslinking agent having an epoxy group, the catalytic action of the reactive emulsifier can increase the reactivity of the crosslinking agent. If the anionic reactive emulsifier is not used, a crosslinking reaction may fail to stop at the stage of aging so that the problem of a change in the peel strength (adhesive strength) of the pressure-sensitive adhesive layer over time may occur. The anionic reactive emulsifier is preferred because it can be incorporated into the polymer and thus prevented from precipitating on the surface of an adherend, so that it will not cause white staining, in contrast to a quaternary ammonium compound (see, for example, JP-A-2007-31585) commonly used as a catalyst for epoxy crosslinking agents, which can precipitate on an adherend.

Such a reactive emulsifier may be a commercially available product such as ADEKA REASOAP SE-10N (trade name) manufactured by ADEKA CORPORATION, AQUALON HS-10 (trade name) manufactured by DAI-ICHI KOGYO SEIYAKU CO., LTD., and AQUALON HS-05 (trade name) manufactured by DAI-ICHI KOGYO SEIYAKU CO., LTD., and AQUALON HS-1025 (trade name) manufactured by DAI-ICHI KOGYO SEIYAKU CO., LTD.

In particular, impurity ions may cause a problem. Therefore, impurity ions should be removed, and the emulsifier to be used should preferably have an SO₄²⁻ ion concentration of 100 μg/g or less. In the case of the anionic emulsifier, an ammonium salt emulsifier is preferably used. Impurities can be removed from the emulsifier using an ion-exchange resin method, a membrane separation method, an impurity precipitation and filtration method with alcohol, or other appropriate methods.

Based on 100 parts by weight of the total amount of the raw material monomers (all the raw material monomers) used to form the acrylic emulsion polymer according to the invention, the amount (use) of the reactive emulsifier is preferably from 0.1 to 10 parts by weight, more preferably from 0.5 to 6 parts by weight, even more preferably from 1 to 4.5 parts by weight. A reactive emulsifier content of 0.1 parts by weight or more is preferable in that stable emulsion can be maintained. On the other hand, a reactive emulsifier content of 10 parts by weight or less is preferable in that the pressure-sensitive adhesive (pressure-sensitive adhesive layer) can have higher cohesive strength, staining on the adherend can be suppressed, and the emulsifier can be prevented from causing staining.

A polymerization initiator may be used in emulsion polymerization to form the acrylic emulsion polymer. Examples of such a polymerization initiator include, but are not limited to, azo polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, and 2,2′-azobis(N,N′-dimethyleneisobutylamidine); persulfates such as potassium persulfate and ammonium persulfate; peroxide polymerization initiators such as benzoyl peroxide and tert-butyl hydroperoxide; and a redox system polymerization initiator including a combination of a peroxide and a reducing agent, such as a combination of a peroxide and ascorbic acid (e.g., a combination of hydrogen peroxide water and ascorbic acid), a combination of a peroxide and an iron (II) salt (e.g., a combination of hydrogen peroxide water and an iron (II) salt), and a combination of a persulfate and sodium hydrogen sulfite.

The amount of addition (use) of the polymerization initiator, which may be appropriately determined depending on the type of the initiator or the raw material monomers, is preferably, but not limited to, 0.01 to 1 part by weight, more preferably 0.02 to 0.5 parts by weight, based on 100 parts by weight of the total amount of the raw material monomers (all the raw material monomers) used to form the acrylic emulsion polymer according to the invention.

The emulsion polymerization for the acrylic emulsion polymer according to the invention may be performed using a conventional method including emulsifying the monomers in water and then subjecting the emulsion to emulation polymerization. This method prepares an aqueous dispersion (polymer emulsion) containing the acrylic emulsion polymer as a base polymer. The emulsion polymerization method may be any known emulsion polymerization method such as a batch mixing method (batch polymerization method), a monomer dropping method, or a monomer emulsion dropping method. In a monomer dropping method or a monomer emulsion dropping method, continuous dropping or intermittent dropping is appropriately selected. These methods may be combined as needed. Reaction conditions and other conditions are appropriately selected, in which, for example, the polymerization temperature is preferably from about 40 to about 95° C., and the polymerization time is preferably from about 30 minutes to about 24 hours.

In the invention, the acrylic emulsion polymer preferably has a solvent-insoluble component content (a content of solvent-insoluble components, also referred to as a “gel fraction”) of 70% (% by weight) or more, more preferably 75% by weight or more, even more preferably 80% by weight or more, in view of less-staining properties or proper peel strength (adhesive strength). If the solvent-insoluble component content is less than 70% by weight, the acrylic emulsion polymer can contain a relatively large amount of low-molecular-weight components, so that only a crosslinking effect cannot sufficiently reduce the amount of low-molecular-weight components in the resulting pressure-sensitive adhesive layer. In this case, the low-molecular-weight components and so on may cause staining on an adherend and may make the peel strength (adhesive strength) too high. The solvent-insoluble component content can be controlled by selecting the polymerization initiator, the reaction temperature, the emulsifier, the type of the raw material monomers, or other conditions. The upper limit of the solvent-insoluble component content is typically, but not limited to, 99% by weight. In the invention, the solvent-insoluble component content of the acrylic emulsion polymer is the value determined by the “method for determining the solvent-insoluble component content” described below.

### (Method for Determining the Solvent-Insoluble Component Content)

About 0.1 g of the acrylic emulsion polymer is sampled and then wrapped in a porous tetrafluoroethylene sheet (NTF1122 (trade name) manufactured by NITTO DENKO CORPORATION) with an average pore size of 0.2 μm. The sheet is then tied with a kite string. The weight of the resulting product is measured and called the weight before immersion. The weight before immersion is the total weight of the acrylic emulsion polymer (sampled as mentioned above), the tetrafluoroethylene sheet, and the kite string. The total weight of the tetrafluoroethylene sheet and the kite string is also measured and called the wrapping weight.

The acrylic emulsion polymer wrapped in the tetrafluoroethylene sheet and tied with the kite string (referred to as the “sample”) is then placed in a 50 ml vessel filled with ethyl acetate and allowed to stand at 23° C. for 7 days. Subsequently, the sample is taken out of the vessel (after the treatment with ethyl acetate) and transferred into an aluminum cup. The sample is dried in a dryer at 130° C. for 2 hours so that the ethyl acetate is removed. The weight of the sample is then measured and called the weight after immersion. The solvent-insoluble component content is calculated from the following formula.

Solvent-insoluble component content (% by weight)={(a−b)/(c−b)}×100 (1). In formula (1), a is the weight after immersion, b is the wrapping weight, and c is the weight before immersion.

The solvent-soluble component (also called “sol component”) of the acrylic emulsion polymer according to the invention preferably has a weight average molecular weight (Mw) of 40,000 to 200,000, more preferably 50,000 to 150,000, even more preferably 60,000 to 100,000. When the solvent-soluble component of the acrylic emulsion polymer has a weight average molecular weight of 40,000 or more, the pressure-sensitive adhesive composition can have higher wettability on the adherend and higher adhesion to the adherend. When the solvent-soluble component of the acrylic emulsion polymer has a weight average molecular weight of 200,000 or less, it is possible to reduce the amount of any residue of the pressure-sensitive adhesive composition potentially remaining on the adherend, so that the less-staining properties to the adherend can be improved. The weight average molecular weight of the solvent-soluble component content of the acrylic emulsion polymer can be determined by the following process. The treatment liquid (the ethyl acetate solution) obtained after the treatment with ethyl acetate in the measurement of the solvent-insoluble component content of the acrylic emulsion polymerization is air-dried at room temperature. The resulting sample (the solvent-soluble component of the acrylic emulsion polymer) is subjected to gel permeation chromatography (GPC). More specifically, the following measurement method may be used.

### [Method for Determining the Weight Average Molecular Weight]

The GPC measurement is performed using a GPC system HLC-8220GPC manufactured by TOSOH CORPORATION to determine the polystyrene-equivalent molecular weight. The measurement conditions are as follows.

Sample concentration: 0.2% by weight (THF solution)

Sample injection volume: 10 μl

Eluent: THF

Flow rate: 0.6 ml/minute

Measurement temperature: 40° C.

Columns:

Sample columns: TSK guard column Super HZ-H×1+TSK gel Super HZM-H×2

Reference column: TSK gel Super H-RC×1

Detector: differential refractometer

### [Non-Water-Soluble Crosslinking Agent]

In the invention, the non-water-soluble crosslinking agent should be a non-water-soluble compound having, in the molecule (per molecule), two or more (e.g., two to six) functional groups capable of reacting with carboxyl groups. The number of functional groups capable of reacting with carboxyl groups is preferably three to five per molecule. As the number of functional groups capable of reacting with carboxyl groups increases per molecule, the pressure-sensitive adhesive composition can be crosslinked more densely (in other words, the polymer used to form a pressure-sensitive adhesive layer can have a dense crosslinked structure). This makes it possible to prevent the pressure-sensitive adhesive layer from wet-spreading after it is formed. In addition, the polymer used to form the pressure-sensitive adhesive layer can be constrained, so that the functional groups (carboxyl groups) in the pressure-sensitive adhesive layer can be prevented from segregating to the surface of the adherend, which makes it possible to prevent the peel strength (adhesive strength) between the pressure-sensitive adhesive layer and the adherend from increasing over time. On the other hand, if the number of functional groups capable of reacting with carboxyl groups is too large or more than six per molecule, a gel may form.

In the non-water-soluble crosslinking agent according to the invention, the functional group capable of reacting with carboxyl groups is typically an epoxy group, an isocyanate group, a carbodiimide group, or the like. In particular, an epoxy group is preferred in view of reactivity. A glycidylamino group is more preferred because it is highly reactive so that it would hardly remain unreacted during the crosslinking reaction, be advantageous for less-staining properties, and be effective in preventing unreacted carboxyl groups in the pressure-sensitive adhesive layer from increasing, over time, the peel strength (adhesive strength) between the pressure-sensitive adhesive layer and the adherend. Specifically, the non-water-soluble crosslinking agent according to the invention is preferably an epoxy crosslinking agent having an epoxy group, more preferably, a crosslinking agent having a glycidylamino group (glycidylamino-containing crosslinking agent). When the non-water-soluble crosslinking agent according to the invention is an epoxy crosslinking agent (especially, a glycidylamino-containing crosslinking agent), the number of epoxy groups (especially, glycidylamino groups) per molecule is preferably two or more (e.g., two to six), more preferably three to five.

In the invention, the non-water-soluble crosslinking agent is a compound insoluble in water. The term “non-water-soluble” means that the solubility in 100 parts by weight of water at 25° C. (the weight of the compound (crosslinking agent) soluble in 100 parts by weight of water) is 5 parts by weight or less, preferably 3 parts by weight or less, more preferably 2 parts by weight or less. When the non-water-soluble crosslinking agent is used, any residue of the crosslinking agent, not undergoing crosslinking, hardly causes white staining on the adherend in a high-humidity environment, so that the less-staining properties can be improved. If a water-soluble crosslinking agent is used, any residue of the crosslinking agent can dissolve in water and easily transfer onto the adherend in a high-humidity environment, so that it can easily cause white staining. As compared with water-soluble crosslinking agents, the non-water-soluble crosslinking agent can highly contribute to the crosslinking reaction (the reaction with carboxyl groups) and be highly effective in preventing the increase in peel strength (adhesive strength) over time. In addition, the non-water-soluble crosslinking agent, which is highly reactive for the crosslinking reaction, can rapidly undergo the crosslinking reaction during aging, so that unreacted carboxyl groups in the pressure-sensitive adhesive layer can be prevented from increasing the peel strength (adhesive strength) between the pressure-sensitive adhesive layer and the adherend over time. If the content of the crosslinking agent is too high, the crosslinking itself may hardly peel, which is not preferred. For example, the solubility of the crosslinking agent in water can be determined as follows.

### [Method for Determining the Solubility in Water]

The same weights of water (25° C.) and the crosslinking agent are mixed using a mixer under the conditions of a rotation speed of 300 rmp and 10 minutes. The mixture is then separated into water and oil phases by centrifugation. The water phase is then collected and dried at 120° C. for 1 hour. The amount of the non-volatile component in the water phase (the parts by weight of the non-volatile component based on 100 parts by weight of water) is determined from the weight loss on drying.

Examples of the non-water-soluble crosslinking agent for the invention include glycidylamino-containing crosslinking agents such as 1,3-bis(N,N-diglycidylaminomethyl)cyclohexane (such as TETRAD-C (trade name) manufactured by MITSUBISHI GAS CHEMICAL COMPANY, INC. (with a solubility of 2 parts by weight or less in 100 parts by weight of water at 25° C.)) and 1,3-bis(N,N-diglycidylaminomethyl)benzene (such as TETRAD-X (trade name) manufactured by MITSUBISHI GAS CHEMICAL COMPANY, INC. (with a solubility of 2 parts by weight or less in 100 parts by weight of water at 25° C.)); and other epoxy crosslinking agents such as tris(2,3-epoxypropyl)isocyanurate (such as TEPIC-G (trade name) manufactured by NISSAN CHEMICAL INDUSTRIES, INC. (with a solubility of 2 parts by weight or less in 100 parts by weight of water at 25° C.)).

In the invention, the content of the non-water-soluble crosslinking agent (the content of the non-water-soluble crosslinking agent in the pressure-sensitive adhesive composition of the invention) is preferably such that the number of moles of the functional group of the non-water-soluble crosslinking agent, wherein the functional group is capable of reacting with a carboxyl group, is from 0.2 to 1.3 moles per mole of the carboxyl group of the carboxyl group-containing unsaturated monomer (ii) used as a raw material monomer to form the acrylic emulsion polymer according to the invention. In other words, the ratio of the total number of moles of the functional groups of the non-water-soluble crosslinking agent, wherein the functional groups are capable of reacting with the carboxyl group, to the total number of moles of the carboxyl groups of all the carboxyl group-containing unsaturated monomers (ii) used as raw material monomers to form the acrylic emulsion polymer in the invention (the molar ratio of the functional groups capable of reacting with the carboxyl groups to the carboxyl groups) is preferably from 0.2 to 1.3, more preferably from 0.3 to 1.3, even more preferably from 0.3 to 1.1, further more preferably from 0.3 to 1.0, most preferably from 0.4 to 1.0. A molar ratio of (the functional groups capable of reacting with the carboxyl groups)/(the carboxyl groups) of 0.2 or more is advantageous in that the amount of unreacted carboxyl groups in the pressure-sensitive adhesive layer can be reduced and that an increase in peel strength (adhesive strength) over time, which is caused by the interaction between the carboxyl groups and the adherend, can be effectively prevented. A molar ratio of (the functional groups capable of reacting with the carboxyl groups)/(the carboxyl groups) of 1.3 or less is advantageous in that the amount of the unreacted non-water-soluble crosslinking agent in the pressure-sensitive adhesive layer can be reduced and that the non-water-soluble crosslinking agent can be suppressed from causing an appearance defect so that appearance characteristics can be improved.

Particularly, when the non-water-soluble crosslinking agent is an epoxy crosslinking agent in the invention, the molar ratio of (the epoxy group)/(the carboxyl group) is preferably from 0.2 to 1.3, more preferably from 0.3 to 1.3, even more preferably from 0.3 to 1.1, further more preferably from 0.3 to 1.0, most preferably from 0.4 to 1.0. Also, when the non-water-soluble crosslinking agent is a glycidylamino-containing crosslinking agent in the invention, the molar ratio of (the glycidylamino group)/(the carboxyl group) preferably falls within the above range.

For example, when 4 g of a non-water-soluble crosslinking agent with a functional group equivalent of 110 (g/eq), wherein the functional group is capable of reacting with a carboxyl group, is added to (or mixed into) the pressure-sensitive adhesive composition, the number of moles of the functional group of the non-water-soluble crosslinking agent, capable of reacting with the carboxyl group, can be typically calculated as follows.

The number of moles of the functional group of the non-water-soluble crosslinking agent, capable of reacting with the carboxyl group=[the added amount of the non-water-soluble crosslinking agent (the added amount)]/[the functional group equivalent]=4/110

For example, when 4 g of an epoxy crosslinking agent with an epoxy equivalent of 110 (g/eq) is added as the non-water-soluble crosslinking agent, the number of moles of the epoxy group of the epoxy crosslinking agent can be typically calculated as follows.

The number of moles of the epoxy group of the epoxy crosslinking agent=[the added amount of the epoxy crosslinking agent (the added amount)]/[the epoxy equivalent]=4/110

The removable water-dispersible acrylic pressure-sensitive adhesive composition of the invention contains an ionic compound as an essential component. When the resulting pressure-sensitive adhesive layer (pressure-sensitive adhesive sheet) is attached to a non-antistatic adherend (the object to be protected) and then peeled off, the ionic compound contained in the composition can impart antistatic properties to the non-antistatic adherend. The ionic compound is also expected to have good compatibility and well-balanced interaction with the acrylic emulsion polymer. An ionic liquid or an alkali metal salt is preferably used as the ionic compound. These may be used singly or in a mixture.

### [Ionic Liquid]

In the invention, the term “ionic liquid” refers to a molten salt (ionic compound) in a liquid state at 25° C. As a non-limiting example, an ionic liquid composed of an organic cation component represented by any one of formulae (A) to (E) below and an anion component is preferably used because such an ionic liquid can have high antistatic performance.

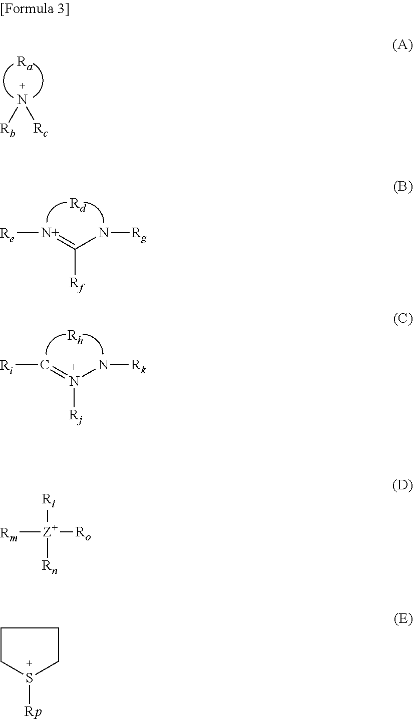

In formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent.

In formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group.

In formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group.

In formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent.

In formula (E), Rₚ represents a hydrocarbon group of 1 to 18 carbon atoms, and part of the hydrocarbon group may be a heteroatom-substituted functional group.

Examples of the cation of formula (A) include a pyridinium cation, a piperidinium cation, a pyrrolidinium cation, a pyrroline skeleton-containing cation, a pyrrole skeleton-containing cation, and a morpholinium cation.

Specific examples include a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1-ethyl-3-hydroxymethylpyridinium cation, a 1,1-dimethylpyrrolidinium cation, a 1-ethyl-1-methylpyrrolidinium cation, a 1-methyl-1-propylpyrrolidinium cation, a 1-methyl-1-butylpyrrolidinium cation, a 1-methyl-1-pentylpyrrolidinium cation, a 1-methyl-1-hexylpyrrolidinium cation, a 1-methyl-1-heptylpyrrolidinium cation, a 1-ethyl-1-propylpyrrolidinium cation, a 1-ethyl-1-butylpyrrolidinium cation, a 1-ethyl-1-pentylpyrrolidinium cation, a 1-ethyl-1-hexylpyrrolidinium cation, a 1-ethyl-1-heptylpyrrolidinium cation, a 1,1-dipropylpyrrolidinium cation, a 1-propyl-1-butylpyrrolidinium cation, a 1,1-dibutylpyrrolidinium cation, a 1-propylpiperidinium cation, a 1-pentylpiperidinium cation, a 1,1-dimethylpiperidinium cation, a 1-methyl-1-ethylpiperidinium cation, a 1-methyl-1-propylpiperidinium cation, a 1-methyl-1-butylpiperidinium cation, a 1-methyl-1-pentylpiperidinium cation, a 1-methyl-1-hexylpiperidinium cation, a 1-methyl-1-heptylpiperidinium cation, a 1-ethyl-1-propylpiperidinium cation, a 1-ethyl-1-butylpiperidinium cation, a 1-ethyl-1-pentylpiperidinium cation, a 1-ethyl-1-hexylpiperidinium cation, a 1-ethyl-1-heptylpiperidinium cation, a 1,1-dipropylpiperidinium cation, a 1-propyl-1-butylpiperidinium cation, a 1,1-dibutylpiperidinium cation, a 2-methyl-1-pyrroline cation, a 1-ethyl-2-phenylindole cation, a 1,2-dimethylindole cation, a 1-ethylcarbazole cation, and an N-ethyl-N-methylmorpholinium cation.

Examples of the cation of formula (B) include an imidazolium cation, a tetrahydropyrimidinium cation, and a dihydropyrimidinium cation.

Specific examples include a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-ocytl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1-(2-hydroxyethyl)-3-methylimidazolium cation, a 1-allyl-3-methylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, and a 1,2,3,4-tetramethyl-1,6-dihydropyrimidinium cation.

Examples of the cation of formula (C) include a pyrazolium cation and a pyrazolinium cation.

Specific examples include a 1-methylpyrazolium cation, a 3-methylpyrazolium cation, a 1-ethyl-2-methylpyrazolinium cation, a 1-ethyl-2,3,5-trimethylpyrazolium cation, a 1-propyl-2,3,5-trimethylpyrazolium cation, a 1-butyl-2,3,5-trimethylpyrazolium cation, a 1-ethyl-2,3,5-trimethylpyrazolinium cation, a 1-propyl-2,3,5-trimethylpyrazolinium cation, and a 1-butyl-2,3,5-trimethylpyrazolinium cation.

Examples of the cation of formula (D) include a tetraalkylammonium cation, a trialkylsulfonium cation, a tetraalkylphosphonium cation, and derivatives thereof in which part of the alkyl group is replaced by an alkenyl group, an alkoxyl group, a hydroxyl group, a cyano group, or an epoxy group.

Examples include tetramethylammonium cation, tetraethylammonium cation, tetrabutylammonium cation, tetrapentylammonium cation, tetrahexylammonium cation, tetraheptylammonium cation, triethylmethylammonium cation, tributylethylammonium cation, trimethyldecylammonium cation, N,N-diethyl-N-methyl-N-(2-methoxyethyl) ammonium cation, glycidyltrimethylammonium cation, trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, tetrahexylphosphonium cation, tetraoctylphosphonium cation, triethylmethylphosphonium cation, tributylethylphosphonium cation, trimethyldecylphosphonium cation, and diallyldimethylammonium cation. In particular, preferably used is asymmetric tetraalkylammonium cation such as triethylmethylammonium cation, tributylethylammonium cation, trimethyldecylammonium cation, diethylmethylsulfonium cation, dibutylethylsulfonium cation, dimethyldecylsulfonium cation, triethylmethylphosphonium cation, tributylethylphosphonium cation, or trimethyldecylphosphonium cation, trialkylsulfonium cation, tetraalkylphosphonium cation, N,N-diethyl-N-methyl-N-(2-methoxyethyl)ammonium cation, glycidyltrimethylammonium cation, diallyldimethylammonium cation, N,N-dimethyl-N-ethyl-N-propylammonium cation, N,N-dimethyl-N-ethyl-N-butylammonium cation, N,N-dimethyl-N-ethyl-N-pentylammonium cation, N,N-dimethyl-N-ethyl-N-hexylammonium cation, N,N-dimethyl-N-ethyl-N-heptylammonium cation, N,N-dimethyl-N-ethyl-N-nonylammonium cation, N,N-dimethyl-N,N-dipropylammonium cation, N,N-diethyl-N-propyl-N-butylammonium cation, N,N-dimethyl-N-propyl-N-pentylammonium cation, N,N-dimethyl-N-propyl-N-hexylammonium cation, N,N-dimethyl-N-propyl-N-heptylammonium cation, N,N-dimethyl-N-butyl-N-hexylammonium cation, N,N-diethyl-N-butyl-N-heptylammonium cation, N,N-dimethyl-N-pentyl-N-hexylammonium cation, N,N-dimethyl-N,N-dihexylammonium cation, trimethylheptylammonium cation, N,N-diethyl-N-methyl-N-propylammonium cation, N,N-diethyl-N-methyl-N-pentylammonium cation, N,N-diethyl-N-methyl-N-heptylammonium cation, N,N-diethyl-N-propyl-N-pentylammonium cation, triethylpropylammonium cation, triethylpentylammonium cation, triethylheptylammonium cation, N,N-dipropyl-N-methyl-N-ethylammonium cation, N,N-dipropyl-N-methyl-N-pentylammonium cation, N,N-dipropyl-N-butyl-N-hexylammonium cation, N,N-dipropyl-N,N-dihexylammonium cation, N,N-dibutyl-N-methyl-N-pentylammonium cation, N,N-dibutyl-N-methyl-N-hexylammonium cation, trioctylmethylammonium cation, N-methyl-N-ethyl-N-propyl-N-pentylammonium cation, or choline cation.

The cation represented by formula (E) may be, for example, a sulfonium cation. The Rₚ group in formula (E) may be, for example, methyl, ethyl, propyl, butyl, hexyl, octyl, nonyl, decyl, dodecyl, tridecyl, tetradecyl, octadecyl, or the like.

In the water-dispersible acrylic pressure-sensitive adhesive composition of the invention, the cation of the ionic liquid is preferably of at least one selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type. These ionic liquids contain one of the cations of formulae (A), (B), and (D).

In the water-dispersible acrylic pressure-sensitive adhesive composition of the invention, the ionic liquid preferably contains at least one cation selected from the group consisting of cations represented by formulae (a) to (d) below. These cations are included in those of formulae (A) and (B).

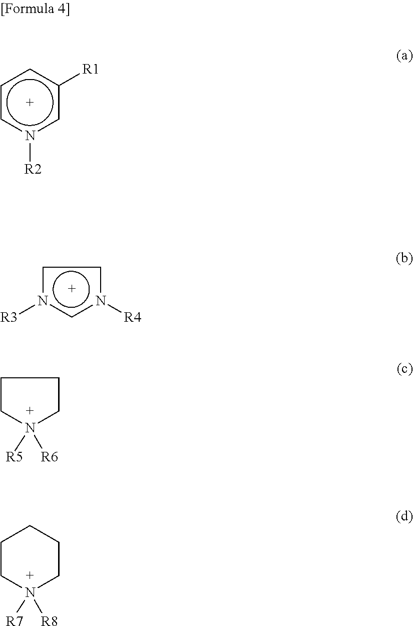

In formula (a), R₁ represents hydrogen or a hydrocarbon group of 1 to 3 carbon atoms, preferably hydrogen or a hydrocarbon group of one carbon atom, and R₂ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (b), R₃ represents hydrogen or a hydrocarbon group of 1 to 3 carbon atoms, preferably hydrogen or a hydrocarbon group of one carbon atom, and R₄ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (c), R₅ represents hydrogen or a hydrocarbon group of 1 to 3 carbon atoms, preferably hydrogen or a hydrocarbon group of one carbon atom, and R₆ represents hydrogen or a hydrocarbon group of 1 to 7 carbon atoms, preferably a hydrocarbon group of 1 to 6 carbon atoms, more preferably a hydrocarbon group of 1 to 4 carbon atoms.

In formula (d), R₇ represents hydrogen or a hydrocarbon group of 1 to 3 carbon atoms, preferably hydrogen or a hydrocarbon group of one carbon atom, and R₈ represents hydrogen or a hydrocarbon group of 1 to 7 carbon atoms, preferably a hydrocarbon group of 1 to 6 carbon atoms, more preferably a hydrocarbon group of 1 to 4 carbon atoms.

On the other hand, any anion component capable of forming the ionic liquid may be used, examples of which include Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, SCN⁻, C₂F₅SO₃⁻, C₃F₇SO₃⁻, C₄F₉SO₃⁻, (FSO₂)₂N⁻, (C₃F₇SO₂)₂N⁻, (C₄F₉SO₂)₂N⁻, (CH₃O)₂PO₂⁻, (C₂HSO)₂PO₂⁻, (CN)₂N⁻, (CN)₃C⁻, CH₃OSO₃⁻, C₄H₉OSO₃⁻, C₂H₅OSO₃⁻, n-C₆H₁₃OSO₃⁻, n-C₈H₁₇OSO₃⁻, CH₃(OC₂H₄)₂OSO₃⁻, (C₂F₅)₃PF₃⁻, and CH₃C₆H₄SO₃⁻. In particular, fluorine atom-containing anion components are preferably used because they can form low-melting-point ionic compounds.

Examples of the ionic liquid used in the invention may be appropriately selected from combinations of any of the above cation components and any of the above anion components. Such examples include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-2-methylimidazolium tetrafluoroborate, 1-ethyl-2-methylimidazolium acetate, 1-ethyl-2-methylimidazolium trifluoroacetate, 1-ethyl-2-methylimidazolium heptafluorobutyrate, 1-ethyl-2-methylimidazolium trifluoromethanesulfonate, 1-ethyl-2-methylimidazolium perfluorobutanesulfonate, 1-ethyl-2-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-2-methylimidazolium tetrafluoroborate, 1-butyl-2-methylimidazolium hexafluorophosphate, 1-butyl-2-methylimidazolium trifluoroacetate, 1-butyl-2-methylimidazolium heptafluorobutyrate, 1-butyl-2-methylimidazolium trifluoromethanesulfonate, 1-butyl-2-methylimidazolium perfluorobutanesulfonate, 1-butyl-3-methylimidazolium bis(trifluoromethanesulfonyl)imide, 1-hexyl-2-methylimidazolium bromide, 1-hexyl-2-methylimidazolium chloride, 1-hexyl-2-methylimidazolium tetrafluoroborate, 1-hexyl-2-methylimidazolium hexafluorophosphate, 1-hexyl-2-methylimidazolium trifluoromethanesulfonate, 1-octyl-2-methylimidazolium tetrafluoroborate, 1-octyl-2-methylimidazolium hexafluorophosphate, 1-hexyl-2,2-dimethylimidazolium tetrafluoroborate, 1,2-dimethyl-3-propylimidazolium bis(trifluoromethanesulfonyl)imide, 1-methylpyrazolium tetrafluoroborate, 2-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium trifluoromethanesulfonate, tetrapentylammonium bis(trifluoromethanesulfonyl)imide, tetrahexylammonium trifluoromethanesulfonate, tetrahexylammonium bis(trifluoromethanesulfonyl)imide, tetraheptylammonium trifluoromethanesulfonate, tetraheptylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, tetraoctylphosphonium trifluoromethanesulfonate, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N-ethyl-N-methylmorpholinium thiocyanate, and 4-ethyl-4-methylmorpholinium methylcarbonate.

The ionic liquid described above may be a commercially available product or may be synthesized as described below. The ionic liquid may be synthesized by any method capable of producing the desired ionic liquid. In general, the ionic liquid is synthesized using methods described in the document titled “Ionic Liquids—the Front Line of Development and the Future—” published by CMC Publishing Co., Ltd., such as halide method, hydroxide method, acid ester method, complex-forming method, and neutralization method.

Hereinafter, how to synthesize nitrogen-containing onium salts by halide method, hydroxide method, acid ester method, complex-forming method, and neutralization method will be shown as an example. It will be understood that other ionic liquids such as sulfur-containing onium salts and phosphorus-containing onium salts can also be obtained by the same techniques.

Halide method is performed using the reactions represented by formulae (1) to (3) below. First, a tertiary amine and an alkyl halide are allowed to react to form a halide (reaction formula (1), the halogen used is chlorine, bromine, or iodine).

The resulting halide is allowed to react with an acid (HA) having the anion structure (A⁻) of the desired ionic liquid or to react with a salt (MA, M is a cation capable of forming a salt with the desired anion, such as ammonium, lithium, sodium, or potassium), so that the desired ionic liquid (R₄NA) is obtained.

[Formula 5]

R₃N+RX→R₄NX (X:Cl, Br, I) (1)

R₄NX+HA→R₄NA+HX (2)

R₄NX+MA→R₄NA+MX (M:NH₄, Li, Na, K, Ag, or the like) (3)

Hydroxide method is performed using the reactions represented by formulae (4) to (8). First, a halide (R₄NX) is subjected to ion exchange membrane electrolysis (reaction formula (4)), OH-type ion exchange resin method (reaction formula (5)), or reaction with silver oxide (Ag₂O) (reaction formula (6)), so that a hydroxide (R₄NOH) is obtained (the halogen used is chlorine, bromine, or iodine).

The resulting hydroxide is subjected to the reactions of formulae (7) and (8) similarly to the halide method, so that the desired ionic liquid (R₄NA) is obtained.

[Formula 6]

R₄NX+H₂O→R₄NOH+½H₂+½X₂ (X:Cl, Br, I) (4)

R₄NX+P—OH→R₄NOH+P—X (P—OH:OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M:NH₄, Li, Na, K, Ag, or the like) (8)

Acid ester method is performed using the reactions represented by formulae (9) to (11) below. First, a tertiary amine (R₃N) is allowed to react with an acid ester to form an acid ester derivative (reaction formula (9), the acid ester used is an ester of an inorganic acid such as sulfuric acid, sulfurous acid, phosphoric acid, phosphorous acid, or carbonic acid or an ester of an organic acid such as methanesulfonic acid, methylphosphonic acid, or formic acid).

The resulting acid ester derivative is subjected to the reactions of formulae (10) and (11) similarly to the halide method, so that the desired ionic liquid (R₄NA) is obtained. Alternatively, methyl trifluoromethanesulfonate, methyl trifluoroacetate, or the like may be used as the acid ester so that the ionic liquid can be directly obtained.

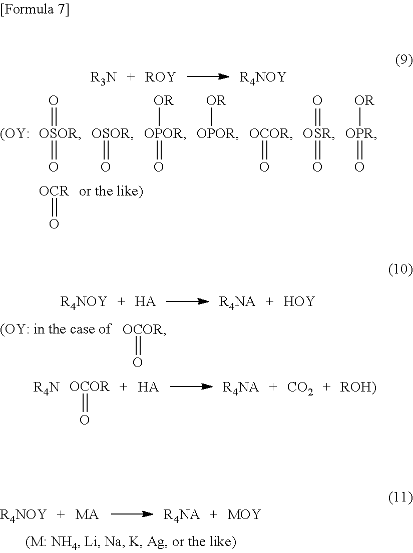

Complex-forming method is performed using the reactions represented by formulae (12) to (15). First, a quaternary ammonium halide (R₄NX), a quaternary ammonium hydroxide (R₄NOH), a quaternary ammonium carbonate (R₄NOCO₂CH₃), or the like is allowed to react with hydrogen fluoride (HF) or ammonium fluoride (NH₄F) to form a quaternary ammonium fluoride salt (reaction formulae (12) to (14)).

The resulting quaternary ammonium fluoride salt is subjected to a complex-forming reaction with a fluoride such as BF₃, AlF₃, PF₅, ASF₅, SbF₅, NbF₅, or TaF₅ so that an ionic liquid can be obtained (reaction formula (15)).

[Formula 8]

R₄NX+HF→R₄NF+HX (X:Cl, Br, I) (12)

R₄NY+HF→R₄NF+HY (Y:OH, OCO₂CH₃) (13)

R₄NY+NH₄F→R₄NF+NH₃+HY (Y:OH, OCO₂CH₃) (14)

R₄NF+MFₙ₋₁→R₄NMFₙ (15)

(MFₙ₋₁═BF₃, AlF₃, PF₅, ASF₅, SbF₅, NbF₅, TaF₅, or the like)

Neutralization method is performed using the reaction represented by formula (16). A tertiary amine is allowed to react with HBF₄, HPF₆, or an organic acid such as CH₃COOH, CF₃COOH, CF₃SO₃H, (CF₃SO₂)₂NH, (CF₃SO₂)₃CH, or (C₂F₅SO₂)₂NH to form an ionic liquid.

[Formula 9]

R₃N+HZ→R₃HN⁺Z⁻ (16)

[HZ: HBF₄, HPF₆, CH₃COOH, CF₃COOH, CF₃SO₃H, An organic acid such as (CF₃SO₂)₂NH, (CF₃SO₂)₃CH, or (C₂F₅SO₂)₂NH]

In formulae (1) to (16), R represents hydrogen or a hydrocarbon group of 1 to 20 carbon atoms, and part of the hydrocarbon group may be a heteroatom-substituted functional group.

The content of the ionic liquid varies with the compatibility between the polymer and the ionic liquid to be used and is not uniquely specified. Based on 100 parts by weight (solid basis) of the base polymer (acrylic emulsion polymer), the content of the ionic liquid is preferably 4.9 parts by weight or less, more preferably from 0.001 to 4.9 parts by weight, even more preferably from 0.001 to 3 parts by weight, further more preferably from 0.01 to 2 parts by weight, most preferably from 0.05 to 1 part by weight. If the content is less than 0.001 parts by weight, sufficient antistatic properties may fail to be obtained, and if the content is more than 4.9 parts by weight, staining on adherends may tend to increase.

### [Alkali Metal Salt]

In the invention, the alkali metal salt is typically, but not limited to, a lithium salt, a sodium salt, or a potassium salt. Specific examples of the metal salt that are preferably used include metal salts composed of any of Li⁺, Na⁺, and K⁺ cations and any of Cl⁻, Br⁻, I⁻, BF₄⁻, PF₆⁻, SCN⁻, ClO₄⁻, CF₃SO₃⁻, (CF₃SO₂)₂N⁻, (C₂F₅SO₂)₂N⁻, (CF₃SO₂)₃C⁻, C₄P₉SO₃⁻, CH₃COO⁻, C₃F₇COO⁻, (CF₃SO₂) (CF₃CO)N−, (FSO₂)₂N⁻, (C₄P₉SO₂)₂N⁻, (CH₃O)₂PO₂⁻, (C₂HSO)₂PO₂⁻, (CN)₂N⁻, CH₃OSO₃⁻, C₂H₅OSO₃⁻, and n-C₈H₁₇OSO₃⁻ anions. In particular, a fluorine-containing anion is preferably used to form the salt. In a preferred mode, a lithium salt such as LiBr, LiI, LiBF₄, LiPF₆, LiSCN, LiClO₄, LiCF₃SO₃, Li(CF₃SO₂)₂N, Li(C₂F₅SO₂)₂N, or Li(CF₃SO₂)₃C is used. Among alkali metal salts, lithium salts are particularly highly dissociative. Using a lithium salt, therefore, a highly antistatic pressure-sensitive adhesive layer (pressure-sensitive adhesive sheet) can be obtained, which can be used as a surface protecting film for optical members and other products that need to be antistatic. These alkali metal salts may be used singly or in combination of two or more.

The content of the alkali metal salt used in the invention is preferably 3 parts by weight or less, more preferably 2 parts by weight or less, even more preferably from 0.1 to 1 part by weight, based on 100 parts by weight of the (meth)acryl-based polymer. If the content is more than 3 parts by weight, staining on the adherend (object to be protected) may tend to increase, which is not preferred.

### [Removable Water-Dispersible Acrylic Pressure-Sensitive Adhesive Composition]

As described above, the removable water-dispersible acrylic pressure-sensitive adhesive composition of the invention contains the acrylic emulsion polymer, the non-water-soluble crosslinking agent, and the ionic compound as essential components. If necessary, the composition may further contain any of a variety of other additives.

In a preferred mode, the pressure-sensitive adhesive composition of the invention is substantially free of what are called nonreactive (non-polymerizable) components (except for water and other components that are evaporated by drying and do not remain in the pressure-sensitive adhesive layer after drying) other than reactive (polymerizable) components capable of being incorporated into the polymer as a component of the pressure-sensitive adhesive layer by reacting (being polymerized) with the raw material monomers or other components of the acrylic emulsion polymer. If nonreactive components remain in the pressure-sensitive adhesive layer, the components may transfer to an adherend to cause white staining in some cases. The term “substantially free of” means that the components are not intentionally added and may be contained as inevitable contaminants. Specifically, the content of such nonreactive components in the pressure-sensitive adhesive composition (nonvolatile components) is preferably less than 1% by weight, more preferably less than 0.1% by weight, even more preferably less than 0.005% by weight.

Examples of such nonreactive components include components capable of bleeding to the surface of the pressure-sensitive adhesive layer and imparting peelability, such as phosphate ester compounds disclosed in JP-A-2006-45412. Examples also include nonreactive emulsifiers such as sodium lauryl sulfate and ammonium lauryl sulfate.

The pressure-sensitive adhesive composition of the invention may contain various additives other than the above as long as the less-staining properties are not affected. Examples of such additives include pigments, fillers, leveling agents, dispersing agents, plasticizers, stabilizers, antioxidants, ultraviolet absorbers, ultraviolet stabilizers, age resisters, and preservatives.

The pressure-sensitive adhesive composition of the invention can be prepared by mixing the acrylic emulsion polymer, the non-water-soluble crosslinking agent, and the ionic compound. If necessary, any of various other additives may be mixed. The mixing method may be a known conventional mixing method for forming an emulsion. As a non-limiting example, stirring using a mixer is preferred. As a non-limiting example of stirring conditions, the stirring temperature is preferably from 10 to 50° C., more preferably from 20 to 35° C. The stirring time is preferably from 5 to 30 minutes, more preferably from 10 to 20 minutes. The stirring speed is preferably from 10 to 3,000 rpm, more preferably from 30 to 1,000 rpm.

### [Pressure-Sensitive Adhesive Layer and Pressure-Sensitive Adhesive Sheet]

The pressure-sensitive adhesive layer (pressure-sensitive adhesive sheet) of the invention is made from the removable water-dispersible acrylic pressure-sensitive adhesive composition. The pressure-sensitive adhesive layer can be formed using any known conventional pressure-sensitive adhesive layer-forming method. The pressure-sensitive adhesive layer can be formed by a process including applying the pressure-sensitive adhesive composition onto a substrate or a release film (release liner) and then drying the composition. The pressure-sensitive adhesive layer formed on the release (separator) film is bonded to a substrate so that it can be transferred onto the substrate.

The pressure-sensitive adhesive layer of the pressure-sensitive adhesive sheet of the invention (after the crosslinking) preferably has a solvent-insoluble component content (gel fraction) of 90% (% by weight) or more, more preferably 95% by weight or more. If the solvent-insoluble component content is less than 90% by weight, transfer of staining matter onto an adherend may increase, so that white staining may occur or the pressure-sensitive adhesive layer may have insufficient removability (or be tough to peel off). The solvent-insoluble component content of the pressure-sensitive adhesive layer (after the crosslinking) can be determined using the same method as that for the solvent-insoluble component content of the acrylic emulsion polymer. Specifically, the solvent-insoluble component content of the pressure-sensitive adhesive layer can be determined using the above method for determining the solvent-insoluble component content, in which the term “acrylic emulsion polymer” shall be replaced by “pressure-sensitive adhesive layer (after the crosslinking).”

In the process of forming the pressure-sensitive adhesive layer (pressure-sensitive adhesive sheet), the drying temperature is generally from about 80 to about 170° C., preferably from 80 to 160° C., and the drying time is generally from about 0.5 to about 30 minutes, preferably from 1 to 10 minutes. Subsequently, curing (aging) should be further performed at room temperature to about 50° C. for 1 day to 1 week, when the pressure-sensitive adhesive layer (pressure-sensitive adhesive sheet) is prepared.

Any of various methods may be used in the step of applying the pressure-sensitive adhesive composition. Examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

In the applying step, the amount of the application is so controlled that a pressure-sensitive adhesive layer can be formed with a desired thickness (post-drying thickness). The thickness (post-drying thickness) of the pressure-sensitive adhesive layer is generally set in the range of about 1 to about 100 μm, preferably in the range of 5 to 50 μm, more preferably in the range of 10 to 40 μm.

Examples of the material used to form the release film include a plastic film such as a polyethylene, polypropylene, polyethylene terephthalate, or polyester film, a porous material such as paper, cloth, or nonwoven fabric, and appropriate thin materials such as a net, a foamed sheet, a metal foil, and a laminate thereof. A plastic film is advantageously used because of its good surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The thickness of the release film is generally from about 5 to about 200 μm, preferably from about 5 to about 100 μm.

If necessary, the release film may be subjected to a release treatment and an anti-pollution treatment with a silicone, fluoride, long-chain alkyl, or fatty acid amide release agent, a silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further improved.

When the pressure-sensitive adhesive layer is exposed, the pressure-sensitive adhesive layer may be protected by the release film until it is actually used. The release film may be used by itself as a separator for the pressure-sensitive adhesive-type optical film, so that the process can be simplified.

The pressure-sensitive adhesive layer (a pressure-sensitive adhesive layer made from the pressure-sensitive adhesive composition of the invention) may be provided on at least one side of a substrate (also referred to as “support” or “support substrate”) to form a pressure-sensitive adhesive sheet (a substrate-attached pressure-sensitive adhesive sheet or a pressure-sensitive adhesive sheet including a substrate and the pressure-sensitive adhesive layer provided on at least one side of the substrate). The pressure-sensitive adhesive layer may also be used by itself as a substrate-less pressure-sensitive adhesive sheet. Hereinafter, the substrate-attached pressure-sensitive adhesive sheet will also be referred to as “the pressure-sensitive adhesive sheet of the invention.”

The pressure-sensitive adhesive sheet of the invention can be obtained, for example, by a process including applying the pressure-sensitive adhesive composition of the invention to at least one surface of a substrate and optionally drying the composition to forma pressure-sensitive adhesive layer on at least one side of the substrate (direct coating process). Crosslinking may be performed by subjecting the pressure-sensitive adhesive sheet to heating or other processes after dehydration or drying in the drying step. Alternatively, the pressure-sensitive adhesive sheet can be obtained by a process including forming the pressure-sensitive adhesive layer temporarily on a release film and then transferring the pressure-sensitive adhesive layer onto a substrate (transfer process). As a non-limiting example, the pressure-sensitive adhesive layer is preferably formed by what is called a direct coating process, which includes applying the pressure-sensitive adhesive composition directly to the surface of a substrate.

The substrate for the pressure-sensitive adhesive sheet of the invention is preferably a plastic substrate (such as a plastic film or a plastic sheet) so that a highly transparent pressure-sensitive adhesive sheet can be obtained. Examples of materials for the plastic substrate include, but are not limited to, polyolefins (polyolefin resins) such as polypropylene and polyethylene, polyesters (polyester resins) such as polyethylene terephthalate (PET), and other transparent resins such as polycarbonate, polyamide, polyimide, acrylic, polystyrene, acetate, polyether sulfone, and triacetylcellulose. These resins may be used singly or in combination of two or more. Among the substrate materials, polyester resins or polyolefin resins are preferably used, and PET, polypropylene, and polyethylene are more preferably used in view of productivity and formability, although the substrate materials are not limited to such materials. Specifically, the substrate is preferably a polyester-based film or a polyolefin-based film, more preferably a PET film, a polypropylene film, or a polyethylene film. The polypropylene may be, but not limited to, a homopolymer (homo-type), an α-olefin random copolymer (random type), or an α-olefin block copolymer (block type). The polyethylene may be low density polyethylene (LDPE), high density polyethylene (HDPE), or linear low density polyethylene (L-LDPE). These may be used singly or in combination of two or more.

The thickness of the substrate is preferably, but not limited to, 10 to 150 μm, more preferably 30 to 100 μm.

In order to have higher adhesion to the pressure-sensitive adhesive layer, the surface of the substrate, on which the pressure-sensitive adhesive layer is to be provided, has preferably undergone an adhesion-facilitating treatment such as an acid treatment, an alkali treatment, a primer treatment, a corona treatment, a plasma treatment, or an ultraviolet ray treatment. An intermediate layer may also be provided between the substrate and the pressure-sensitive adhesive layer. The thickness of the intermediate layer is, for example, preferably from 0.01 to 1 μm, more preferably from 0.05 to 1 μm, even more preferably from 0.1 to 1 μm.

The pressure-sensitive adhesive sheet of the invention may be wound into a roll with the pressure-sensitive adhesive layer being protected by the release film (separator). The back surface of the pressure-sensitive adhesive sheet (the surface opposite to the side on which the pressure-sensitive adhesive layer is provided) may be subjected to a release treatment and/or an anti-pollution treatment with a silicone, fluoride, long-chain alkyl, or fatty acid amide release agent, a silica powder or the like, so that a back surface treatment layer (a release treatment layer and/or an anti-pollution treatment layer) may be provided on the back surface of the pressure-sensitive adhesive sheet. In particular, the pressure-sensitive adhesive sheet of the invention preferably has a structure of pressure-sensitive adhesive layer/substrate/back surface treatment layer.

In addition, the pressure-sensitive adhesive sheet of the invention more preferably has undergone an antistatic treatment. Such an antistatic treatment may be performed using any common antistatic treatment method such as a method of providing an antistatic layer on the back surface of the substrate (the surface opposite to the pressure-sensitive adhesive layer side) or a method of kneading a kneading-type antistatic agent into the substrate.

Examples of the method of providing an antistatic layer include a method of applying an antistatic agent, an antistatic resin composed of an antistatic agent and a resin component, a conductive resin composition containing a conductive material and a resin component, or a conductive polymer; and a method of vapor-depositing a conductive material or plating the object with a conductive material.

Examples of the antistatic agent include cationic antistatic agents such as quaternary ammonium salts, pyridinium salts, and others having a cationic functional group (such as a primary, secondary, or tertiary amino group); anionic antistatic agents such as sulfonates, sulfuric ester salts, phosphonates, phosphoric ester salts, and others having an anionic functional group; amphoteric antistatic agents such as alkylbetaine and derivatives thereof, imidazoline and derivatives thereof, and alanine and derivatives thereof; nonionic antistatic agents such as aminoalcohol and derivatives thereof, glycerin and derivatives thereof, and polyethylene glycol and derivatives thereof; and ion-conducting polymers obtained by polymerization or copolymerization of ion-conducting group-containing monomers such as the cationic, anionic, or amphoteric antistatic agents.

Specific examples of the cationic antistatic agents include alkyltrimethylammonium salts, acyloylamidopropyltrimethylammonium methosulfate, alkylbenzylmethylammonium salts, acylcholine chloride, quaternary ammonium group-containing (meth)acrylate copolymers such as polydimethylaminoethyl methacrylate, quaternary ammonium group-containing styrene copolymers such as polyvinylbenzyltrimethylammonium chloride, and quaternary ammonium group-containing diallylamine copolymers such as polydiallyldimethylammonium chloride. Examples of the anionic antistatic agents include alkylsulfonate salts, alkylbenzene sulfonate salts, alkylsulfate ester salts, alkylethoxysulfate ester salts, alkylphosphate ester salts, and sulfonic acid group-containing styrene copolymers. Examples of the amphoteric antistatic agents include alkylbetaine, alkylimidazolium betaine, and carbobetaine graft copolymers. Examples of the nonionic antistatic agents include fatty acid alkylolamide, di-(2-hydroxyethyl)alkylamine, polyoxyethylenealkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylenediamine, a copolymer composed of polyether, polyester, and polyamide, and methoxypolyethylene glycol(meth)acrylate.

Examples of the conductive polymers include polyaniline, polypyrrole, and polythiophene.

Examples of the conductive materials include tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof.

General-purpose resin such as polyester resin, acrylic resin, polyvinyl resin, urethane resin, melamine resin, or epoxy resin may be used as the resin component. When the antistatic agent is a polymer-type antistatic agent, the antistatic resin does not need to contain the resin component. The antistatic resin may also contain, as a crosslinking agent, a methylolated or alkylolated melamine, urea, glyoxal, or acrylamide compound, an epoxy compound, or an isocyanate compound.

The antistatic layer may be formed by a coating method including diluting the antistatic resin, the conductive polymer, or the conductive resin composition with an organic solvent, water or any other solvent or dispersion medium, then applying the resulting coating liquid to a substrate, and drying the coating. Examples of the organic solvent include methyl ethyl ketone, acetone, ethyl acetate, tetrahydrofuran, dioxane, cyclohexanone, n-hexane, toluene, xylene, methanol, ethanol, n-propanol, and isopropanol. These may be used singly or in combination of two or more. The method of application may be performed using a known coating technique, examples of which include roll coating, gravure coating, reverse coating, roll brush coating, spray coating, air knife coating, impregnation, and curtain coating.

The antistatic layer formed by the coating (an antistatic resin layer, a conductive polymer layer, or a conductive resin composition layer) preferably has a thickness of 0.001 to 5 μm, more preferably 0.005 to 1 μm.

Methods for vapor-deposition of the conductive material and methods for plating with the conductive material include vacuum deposition, sputtering, ion plating, chemical vapor deposition, spray pyrolysis, chemical plating, and electroplating.

The antistatic layer (conductive material layer) formed by the vapor deposition or plating preferably has a thickness of 20 to 10,000 Å (0.002 to 1 μm), more preferably 50 to 5,000 Å (0.005 to 0.5 μm).

Any of the above antistatic agents may be appropriately used as the kneading-type antistatic agent. The content of the kneading-type antistatic agent is preferably 20% by weight or less, more preferably 0.05 to 10% by weight, based on the total weight of the substrate (100% by weight). The kneading method may be any method capable of uniformly mixing the kneading-type antistatic agent into, for example, a resin for use in the plastic substrate. Examples generally include methods using a heating roll, a Banbury mixer, a pressure kneader, a biaxial kneading machine, etc.

The removable water-dispersible acrylic pressure-sensitive adhesive composition of the invention is capable of forming a removable, pressure-sensitive adhesive layer having a good level of antistatic properties, adhesion, and removability (easy peelability). The pressure-sensitive adhesive composition of the invention can be used to form pressure-sensitive adhesive layers for removable applications (removable purposes). Specifically, the pressure-sensitive adhesive sheet having the pressure-sensitive adhesive layer is preferably used for removable applications (e.g., masking tapes such as masking tapes for building curing, masking tapes for automobile painting, masking tapes for electronic components (such as lead frames and printed boards), and masking tapes for sandblasting; surface protecting films such as surface protecting films for aluminum sashes, surface protecting films for optical plastics, surface protecting films for optical glass products, surface protecting films for automobile protection, and surface protecting films for metal plates; pressure-sensitive adhesive tapes for use in semiconductor and electronic component processes, such as back grinding tapes, pellicle fixing tapes, dicing tapes, lead frame fixing tapes, cleaning tapes, dust removing tapes, carrier tapes, and cover tapes; tapes for packing electronic devices or electronic components; tapes for temporary bonding during transportation; binding tapes; and labels).

When attached to and used on an adherend, the pressure-sensitive adhesive layer and pressure-sensitive adhesive sheet of the invention made from the water-dispersible acrylic pressure-sensitive adhesive composition of the invention does not cause the adherend to suffer from staining such as white staining and is highly less-staining. Thus, the pressure-sensitive adhesive sheet of the invention is advantageously used in surface protection applications, especially requiring less-staining properties, for optical members (such as optical plastics, optical glass products, and optical films) such as polarizing plates, retardation plates, anti-reflection plates, wavelength plates, optical compensation films, and brightness enhancement films for constituting panels for liquid crystal displays, organic electroluminescence (organic EL) displays, field emission displays, and other displays. It will be understood that such applications are non-limiting and that there are other applications such as surface protection and breakage prevention during the manufacture of fine-processed products such as semiconductors, circuits, a variety of printed boards, a variety of masks, and lead frames, removal of foreign bodies and the like, and masking.

### EXAMPLES

Hereinafter, the invention will be more specifically described with reference to examples, which however are not intended to limit the invention. In the description below, “parts” and “%” are by weight unless otherwise specified.

### Example 1-1

### Preparation of Acrylic Emulsion Polymer

To a vessel were added 90 parts by weight of water and 96 parts by weight of 2-ethylhexyl acrylate (2EHA), 4 parts by weight of acrylic acid (AA), and 3 parts by weight of a reactive nonionic-anionic emulsifier (AQUALON HS-1025 (trade name) manufactured by Dai-ichi Kogyo Seiyaku Co., Ltd.) as shown in Table 1 and then mixed by stirring with a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight part of the monomer emulsion. The mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring. The mixture was then subjected to reaction at 75° C. for 3 hours. Subsequently, after the reaction mixture was cooled to 30° C., 10% by weight ammonia water was added to adjust its pH to 8, so that an aqueous dispersion of an acrylic emulsion polymer (41% by weight in acrylic emulsion polymer concentration) was obtained. The polymer had a solvent-insoluble component content of 83%, and the weight average molecular weight of the solvent-soluble component of the polymer was 80,000.

### (Preparation of Removable Water-Dispersible Acrylic Pressure-Sensitive Adhesive Composition)

Based on 100 parts by weight (solid basis) of the acrylic emulsion polymer (238 parts by weight of the aqueous dispersion (42% by weight)), 2.0 parts by weight of an epoxy crosslinking agent (TETRAD-C(trade name) manufactured by MITSUBISHI GAS CHEMICAL COMPANY, INC., 1,3-bis(N,N-diglycidylaminomethyl)cyclohexane, 110 in epoxy equivalent, 4 in the number of functional groups) as a non-water-soluble crosslinking agent and 1 part by weight of a pyridinium-type-cation-containing ionic liquid (CIL-313 (trade name) manufactured by Japan Carlit Co., Ltd., N-butyl-3-methylpyridinium trifluoromethanesulfonate, 100% by weight in active component content) were mixed into the aqueous dispersion of the acrylic emulsion polymer by stirring with a mixer under the stirring conditions of 23° C., 300 rpm, and 10 minutes to form a removable water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the removable water-dispersible acrylic pressure-sensitive adhesive composition was applied (coated) onto the corona-treated surface of a PET film (E7415 (trade name) manufactured by TOYOBO CO., LTD., 38 μm in thickness) so that a 15-μm-thick coating would be formed after drying. Subsequently, the coated film was dried at 120° C. for 2 minutes in a hot air circulating oven and then aged at room temperature for 1 week to give a pressure-sensitive adhesive sheet.

### Examples 1-2 to 1-11 and Comparative Examples 1-1 to 1-6

Removable water-dispersible acrylic pressure-sensitive adhesive compositions were prepared as in Example 1-1, except that the type and content of the crosslinking agent, the ionic liquid, and other components, and other conditions were changed as shown in Tables 1 and 2. In the preparation, the additives not shown in the tables were used in the same amounts as those in Example 1-1. Using the removable water-dispersible acrylic pressure-sensitive adhesive compositions, pressure-sensitive adhesive sheets were obtained as in Example 1-1.

### [Evaluations]

The water-dispersible acrylic pressure-sensitive adhesive compositions and the pressure-sensitive adhesive sheets obtained in the examples and the comparative examples were evaluated using the measurement method or the evaluation method described below. Table 1 shows the results of the evaluation.

### (1) Peeling Electrification Voltage

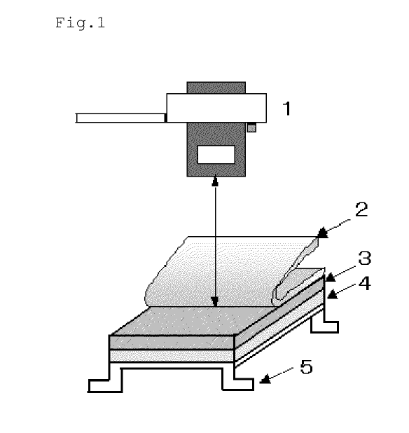

The prepared pressure-sensitive adhesive sheet was cut into a piece with a size of 70 mm in width and 130 mm in length, and the separator was peeled off. An acrylic plate (ACRYLITE manufactured by Mitsubishi Rayon Co., Ltd, 1 mm thick, 70 mm wide, and 100 mm long) was subjected to static elimination in advance, and a polarizing plate (SEG1425DU (trade name) manufactured by NITTO DENKO CORPORATION) was then bonded to the acrylic plate. Using a hand roller, the piece was then pressure-bonded to the surface of the polarizing plate in such away that one end of the piece protruded 30 mm out of the plate. Subsequently, the resulting sample was allowed to stand in an environment at 23° C. and 24±2% RH for a day and then set at a predetermined location as shown in FIG. 1. The one end protruding 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 24±2% RH.

The pressure-sensitive adhesive sheet of the invention preferably has a peeling electrification voltage (absolute value) of 1.3 kV or less, more preferably 1.0 kV or less. If the peeling electrification voltage exceeds 1.3 kV, the pressure-sensitive adhesive sheet being peeled off can easily adsorb dust, which is not preferred.

### (2) Ability to Prevent Increase in Peel Strength (Initial Peel Strength)

The prepared pressure-sensitive adhesive sheet was cut into a piece with a size of 25 mm in width and 100 mm in length, and the separator was peeled off. Using a laminator (Compact Laminator manufactured by TESTER SANGYO CO., LTD.), the resulting piece was then laminated onto a polarizing plate (SEG1425DU manufactured by NITTO DENKO CORPORATION, 70 mm wide, 100 mm long) under the conditions of 0.25 MPa and 0.3 m/minute to form an evaluation sample.

After the lamination, the sample was allowed to stand in an environment at 23° C. and 50% RH for 30 minutes and then measured for peel strength (adhesive strength) (N/25 mm) at a peel angle of 180° and a peeling rate of 10 m/minute using a universal tensile tester. The measured peel strength was called the “initial peel strength.” The measurement was performed in an environment at 23° C. and 50% RH.

The pressure-sensitive adhesive sheet of the invention preferably has an initial peel strength of 0.1 to 1.3 N/25 mm, more preferably 0.2 to 1.2 N/25 mm. The pressure-sensitive adhesive sheet with a peel strength of 1.3 N/25 mm or less is preferable in that it can be easily peeled off to make productivity or handleability higher in the process of manufacturing polarizing plates or liquid crystal display devices. The pressure-sensitive adhesive sheet with a peel strength of 0.1 N/25 mm or more is preferable in that it can be prevented from lifting or peeling in manufacturing processes and can sufficiently function as a surface protecting sheet.

(Peel Strength after Bonding and Storing at 40° C. for 1 Week (Peel Strength Over Time))

The sample obtained by laminating the pressure-sensitive adhesive sheet and the polarizing plate was stored in an environment at 40° C. for 1 week and then allowed to stand in an environment at 23° C. and 50% RH for 2 hours. The sample was then subjected to a 180° peel test at a peeling rate of 10 m/minute, in which the peel strength (adhesive strength) (N/25 mm) between the pressure-sensitive adhesive sheet and the polarizing plate was measured and called the “peel strength over time.”

If the difference between the peel strength over time and the initial peel strength [(the peel strength over time)−(the initial peel strength)] is less than 0.5 N/25 mm, the pressure-sensitive adhesive sheet can be judged to be superior in the ability to prevent an increase in peel strength (adhesive strength). The difference between the peel strength over time and the initial peel strength [(the peel strength over time)−(the initial peel strength)] of the pressure-sensitive adhesive sheet of the invention is preferably less than 0.5 N/25 mm, more preferably 0.0 to 0.2 N/25 mm. If the difference is 0.5 N/25 mm or more, the ability to prevent an increase in peel strength (adhesive strength) can be poor, so that the workability of removal of the pressure-sensitive adhesive sheet may degrade in some cases.

### (3) Less-Staining Properties (White Staining)

### [Humidity Test]

Using a laminator (Compact Laminator manufactured by TESTER SANGYO CO., LTD.), the pressure-sensitive adhesive sheet (sample size: 25 mm wide and 100 mm long) obtained in each of the examples and the comparative examples was laminated onto a polarizing plate (SEG1425DU (trade name) manufactured by NITTO DENKO CORPORATION, size: 70 mm wide and 120 mm long) under the conditions of 0.25 MPa and 0.3 m/minute.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours. The surface of the polarizing plate was then visually observed and evaluated for less-staining properties according to the criteria shown below. If white staining occurs on the polarizing plate as the adherend under the humidified conditions (high-humidity conditions) after the bonding and peeling off of the pressure-sensitive adhesive sheet, the less-staining properties of the pressure-sensitive adhesive sheet can be judged to be not enough for optical member surface-protecting film applications.

Good level of less-staining properties (o): No change was observed in the part where the pressure-sensitive adhesive sheet had been bonded and in the part where it had not been bonded.

Poor level of less-staining properties (x): White staining was observed in the part where the pressure-sensitive adhesive sheet had been bonded.

TABLE 1

| | | | Example | | | | | | | | | | |
|---|---|---|---|---|---|---|---|---|---|---|---|---|---|
| Components and evaluation results | | | 1-1 | 1-2 | 1-3 | 1-4 | 1-5 | 1-6 | 1-7 | 1-8 | 1-9 | 1-10 | 1-11 |
| Acrylic | Monomer components | 2EHA | 96 | 96 | 96 | 96 | 96 | 96 | 96 | 96 | 96 | 98 | 92 |
| emulsion | | AA | 4 | 4 | 4 | 4 | 4 | 4 | 4 | 4 | 4 | 2 | 8 |
| polymer (parts | Reactive emulsifier | HS-1025 | 3 | 3 | 3 | 3 | 3 | 3 | 3 | 3 | 3 | 3 | 3 |
| by weight) | | | | | | | | | | | | | |
| Pressure- | Acrylic emulsion polymer | | 100 | 100 | 100 | 100 | 100 | 100 | 100 | 100 | 100 | 100 | 100 |
| sensitive | Non-water-soluble | T/C | 2 | 2.5 | 2.5 | 2.5 | 2.5 | 2.5 | 2.5 | 2.5 | 2.5 | 2 | 5 |
| adhesive | crosslinking agent | | | | | | | | | | | | |
| composition | Water-soluble | EX-512 | | | | | | | | | | | |
| (parts by | crosslinking agent | | | | | | | | | | | | |
| weight) | [Number of moles of epoxy group (glycidylamino | | 0.3 | 0.4 | 0.4 | 0.4 | 0.4 | 0.4 | 0.4 | 0.4 | 0.4 | 0.6 | 0.4 |
| | group)]/[number of moles of carboxyl group] | | | | | | | | | | | | |
| | (molar ratio) | | | | | | | | | | | | |
| | Ionic liquid | CIL-313 | 1 | | | | | | | | | 1 | |
| | | EtMePy-EF11 | | 1 | | | | | | | | | |
| | | EtMePy-EF31 | | | 3 | | | | | | | | 3 |
| | | EtMePy-EF41 | | | | 1 | | | | | | | |
| | | IL-110 | | | | | 0.5 | | | | | | |
| | | IL-120 | | | | | | 0.5 | | | | | |
| | | IL-130 | | | | | | | 3 | | | | |
| | | IL-210 | | | | | | | | 1 | | | |
| | | IL-230 | | | | | | | | | 3 | | |
| | Solvent-insoluble component content (wt %) | | 96 | 97 | 94 | 96 | 97 | 96 | 94 | 96 | 95 | 90 | 95 |
| | after crosslinking | | | | | | | | | | | | |
| | Weight average molecular weight (Mw) (×10⁴) | | 8 | 8 | 8 | 8 | 8 | 8 | 8 | 8 | 8 | 10 | 8 |
| | of solvent-soluble component | | | | | | | | | | | | |
| Pressure- | Peeling electrification | Absolute value (kV) | 0.2 | 0.0 | 0.0 | 0.0 | 0.0 | 0.0 | 0.0 | 0.0 | 0.0 | 0.1 | 0.2 |
| sensitive | voltage | at peeling rate 10 m/min | | | | | | | | | | | |
| adhesive sheet | Ability to prevent | Initial peel strength | 0.7 | 0.6 | 0.5 | 0.6 | 0.7 | 0.7 | 0.5 | 0.6 | 0.5 | 0.5 | 0.2 |
| | increase in peel strength | (N/25 mm) at peeling rate | | | | | | | | | | | |
| | (adhesive strength) | 10 m/min | | | | | | | | | | | |
| | | Peel strength (N/25 mm) | 0.8 | 0.5 | 0.5 | 0.5 | 0.6 | 0.7 | 0.5 | 0.5 | 0.5 | 0.5 | 0.2 |
| | | over time at peeling rate | | | | | | | | | | | |
| | | 10 m/min | | | | | | | | | | | |

| | | | | | | | | | | | |
|---|---|---|---|---|---|---|---|---|---|---|---|
| Less-staining properties (against white staining) | ◯ | ◯ | ◯ | ◯ | ◯ | ◯ | ◯ | ◯ | ◯ | ◯ | ◯ |

TABLE 2

| | | | Comparative Example | | | | | |
|---|---|---|---|---|---|---|---|---|
| Components and evaluation results | | | 1-1 | 1-2 | 1-3 | 1-4 | 1-5 | 1-6 |
| Acrylic | Monomer components | 2EHA | 96 | 96 | 96 | 96 | 100 | 85 |
| emulsion | | AA | 4 | 4 | 4 | 4 | | 15 |
| polymer | Reactive emulsifier | HS-1025 | 3 | 3 | 3 | 3 | 3 | 3 |
| (parts by | | | | | | | | |
| weight) | | | | | | | | |

| Pressure- | Acrylic emulsion polymer | | 100 | 100 | 100 | 100 | Pressure-sensitive adhesive sheet was not able to be |
|---|---|---|---|---|---|---|---|
| sensitive | Non-water-soluble | T/C | 2.5 | | 8.8 | | prepared due to formation of aggregate during |
| adhesive | crosslinking agent | | | | | | preparation of acrylic emulsion polymer. |
| composition | Water-soluble | EX-512 | | 4.6 | | 10 | |
| (parts by | crosslinking agent | | | | | | |
| weight) | [Number of moles of epoxy group | | 0.4 | 0.5 | 1.5 | 0.8 | |
| | (glycidylamino group)]/[number of moles of | | | | | | |
| | carboxyl group] (molar ratio) | | | | | | |
| | Ionic liquid | CIL-313 | | | | 5 | |
| | | EtMePy-EF11 | | | | | |
| | | EtMePy-EF31 | | | | | |
| | | EtMePy-EF41 | | | | | |
| | | IL-110 | | | | | |
| | | IL-120 | | | | | |
| | | IL-130 | | | | | |
| | | IL-210 | | | | | |
| | | IL-230 | | | | | |
| | Solvent-insoluble component content (wt %) | | 97 | 89 | 98 | 85 | |
| | after crosslinking | | | | | | |
| | Weight average molecular weight (Mw) (×10⁴) | | 8 | 8 | 8 | 8 | |
| | of solvent-soluble component | | | | | | |
| Pressure- | Peeling electrification | Absolute value (kV) | 1.5 | 2.3 | 1.8 | 0.4 | |
| sensitive | voltage | at peeling rate | | | | | |
| | | 10 m/min | | | | | |
| adhesive sheet | Ability to prevent | Initial peel strength | 0.5 | 0.1 | Not | 0.7 | |
| | increase in | (N/25 mm) at peeling | | | evaluable | | |
| | peel strength | rate 10 m/min | | | | | |
| | (adhesive strength) | Peel strength | 0.5 | 0.2 | Not | 2.3 | |
| | | (N/25 mm) over time | | | evaluable | | |
| | | at peeling rate | | | | | |
| | | 10 m/min | | | | | |

| | | | | |
|---|---|---|---|---|
| Less-staining properties (against white staining) | ◯ | X | ◯ | X |

In Tables 1 and 2, the weight of the solid is shown with respect to each component. The following abbreviations are used in Tables 1 and 2.

2EHA: 2-ethylhexyl acrylate

AA: Acrylic acid

HS-1025: AQUALON HS-1025 (trade name) manufactured by Dai-ichi Kogyo Seiyaku Co., Ltd. (a reactive nonionic-anionic emulsifier)

T/C: TETRAD-C(trade name) manufactured by MITSUBISHI GAS CHEMICAL COMPANY, INC. (1,3-bis(N,N-diglycidylaminomethyl)cyclohexane, 110 in epoxy equivalent, 4 in the number of functional groups) (a non-water-soluble crosslinking agent)

EX-512: Denacol EX-512 (trade name) manufactured by Nagase ChemteX Corporation (polyglycerol polyglycidyl ether, 168 in epoxy equivalent, 4 in the number of functional groups) (a water-soluble crosslinking agent)

CIL-313: N-butyl-3-methylpyridinium trifluoromethanesulfonate (water-soluble) manufactured by Japan Carlit Co., Ltd.

EtMePy-EF11: N-ethyl-3-methylpyridinium trifluoromethanesulfonate (water-soluble) manufactured by Mitsubishi Materials Corporation

EtMePy-EF31: N-ethyl-3-methylpyridinium perfluoropropanesulfonate (water-soluble) manufactured by Mitsubishi Materials Corporation

EtMePy-EF41: N-ethyl-3-methylpyridinium perfluorobutanesulfonate (water-soluble) manufactured by Mitsubishi Materials Corporation

IL-110: 1-ethyl-3-methylimidazolium bis(fluorosulfonyl)imide (non-water-soluble) manufactured by Dai-ichi Kogyo Seiyaku Co., Ltd.

IL-120: 1-methyl-1-propylpyrrolidinium bis(fluorosulfonyl)imide (non-water-soluble) manufactured by Dai-ichi Kogyo Seiyaku Co., Ltd.

IL-130: 1-methyl-1-propylpiperidinium bis(fluorosulfonyl)imide (non-water-soluble) manufactured by Dai-ichi Kogyo Seiyaku Co., Ltd.

IL-210: 1-ethyl-3-methylimidazolium bis(trifluoromethylsulfonyl)imide (non-water-soluble) manufactured by Dai-ichi Kogyo Seiyaku Co., Ltd.

IL-230: 1-methyl-1-propylpiperidinium bis(trifluoromethylsulfonyl)imide (non-water-soluble) manufactured by Dai-ichi Kogyo Seiyaku Co., Ltd.

From the evaluation results in Table 1, it has been found that in all the examples (Examples 1-1 to 1-11), the resulting pressure-sensitive adhesive layers (pressure-sensitive adhesive sheets) are superior not only in antistatic properties, removability, and the ability to prevent an increase in peel strength (adhesive strength) over time, but also in less-staining properties on adherends, especially, the ability to prevent white staining on adherends in a high-humidity environment (the ability to prevent white staining).

On the other hand, the evaluation results in Table 2 show as follows. In Comparative Example 1-1 where the ionic liquid as an antistatic agent was not added, a high peeling electrification voltage was obtained. In Comparative Example 1-2 where the non-water-soluble crosslinking agent was also not added, not only the antistatic properties were poor, but also the less-staining properties were inferior. In Comparative Example 1-3, not only the antistatic properties were poor, but also the peel strength itself was not able to be measured. In Comparative Example 1-4 where the non-water-soluble crosslinking agent was not added, the antistatic properties were inferior to those in the examples, even though the ionic liquid was added in Comparative Example 1-4. In Comparative Example 1-4, the difference between the initial peel strength and the peel strength over time was relatively large, the ability to prevent an increase in peel strength was inferior, and the less-staining properties were also inferior. In Comparative Examples 1-5 and 1-6 where the content of the alkyl(meth)acrylate or the carboxyl group-containing unsaturated monomer did not fall within the desired range, the pressure-sensitive adhesive sheet was not able to be prepared due to the formation of an aggregate in the process of preparing the acrylic emulsion polymer.

### Example 2-1

### Preparation of Acrylic Emulsion Polymer

To a vessel were added 90 parts by weight of water and 96 parts by weight of 2-ethylhexyl acrylate (2EHA), 4 parts by weight of acrylic acid (AA), and 3 parts by weight of a reactive nonionic-anionic emulsifier (AQUALON HS-1025 (trade name) manufactured by Dai-ichi Kogyo Seiyaku Co., Ltd.) as shown in Table 3 and then mixed by stirring with a homomixer to form a monomer emulsion.

A reaction vessel equipped with a condenser tube, a nitrogen-introducing tube, a thermometer, and a stirrer was then charged with 50 parts by weight of water, 0.01 parts by weight of a polymerization initiator (ammonium persulfate), and 10% by weight part of the monomer emulsion. The mixture was subjected to emulsion polymerization at 65° C. for 1 hour with stirring. Subsequently, after 0.05 parts by weight of a polymerization initiator (ammonium persulfate) was further added, all the remaining part (90% by weight part) of the monomer emulsion was added over 3 hours with stirring. The mixture was then subjected to reaction at 75° C. for 3 hours. Subsequently, after the reaction mixture was cooled to 30° C., 10% by weight ammonia water was added to adjust its pH to 8, so that an aqueous dispersion of an acrylic emulsion polymer (41% by weight in acrylic emulsion polymer concentration) was obtained.

### (Preparation of Removable Water-Dispersible Acrylic Pressure-Sensitive Adhesive Composition)

Based on 100 parts by weight (solid basis) of the acrylic emulsion polymer, 2.0 parts by weight of an epoxy crosslinking agent (TETRAD-C(trade name) manufactured by MITSUBISHI GAS CHEMICAL COMPANY, INC., 1,3-bis(N,N-diglycidylaminomethyl)cyclohexane, 110 in epoxy equivalent, 4 in the number of functional groups) as a non-water-soluble crosslinking agent and 2 parts by weight of lithium trifluoromethanesulfonate (in the form of a 50% by weight aqueous solution) were mixed into the aqueous dispersion of the acrylic emulsion polymer by stirring with a mixer under the stirring conditions of 23° C., 300 rpm, and 10 minutes to form a removable water-dispersible acrylic pressure-sensitive adhesive composition.

### (Formation of Pressure-Sensitive Adhesive Layer and Preparation of Pressure-Sensitive Adhesive Sheet)

Using an applicator manufactured by TESTER SANGYO CO., LTD., the removable water-dispersible acrylic pressure-sensitive adhesive composition was applied (coated) onto the corona-treated surface of a PET film (E7415 (trade name) manufactured by TOYOBO CO., LTD., 38 μm in thickness) so that a 15-μm-thick coating would be formed after drying. Subsequently, the coated film was dried at 120° C. for 2 minutes in a hot air circulating oven and then aged at room temperature for 1 week to give a pressure-sensitive adhesive sheet.

### Examples 2-2 to 2-5 and Comparative Examples 2-1 to 2-6

Monomer emulsions were prepared as in Example 2-1, except that the type of the raw material monomers, the content of the materials, and other conditions were changed as shown in Table 3. In the preparation, the additives not shown in the table were used in the same amounts as those in Example 2-1. Using the monomer emulsions, removable water-dispersible acrylic pressure-sensitive adhesive compositions and pressure-sensitive adhesive sheets were obtained as in Example 2-1.

### [Evaluations]

The water-dispersible acrylic pressure-sensitive adhesive compositions and the pressure-sensitive adhesive sheets obtained in the examples and the comparative examples were evaluated using the measurement method or the evaluation method described below. Table 3 shows the results of the evaluation.

### (1) Peeling Electrification Voltage

The prepared pressure-sensitive adhesive sheet was cut into a piece with a size of 70 mm in width and 130 mm in length, and the separator was peeled off. An acrylic plate (ACRYLITE manufactured by Mitsubishi Rayon Co., Ltd, 1 mm thick, 70 mm wide, and 100 mm long) was subjected to static elimination in advance, and a polarizing plate (SEG1425DU (trade name) manufactured by NITTO DENKO CORPORATION) was then bonded to the acrylic plate. Using a hand roller, the piece was then pressure-bonded to the surface of the polarizing plate in such away that one end of the piece protruded 30 mm out of the plate. Subsequently, the resulting sample was allowed to stand in an environment at 23° C. and 24±2% RH for a day and then set at a predetermined location as shown in FIG. 1. The one end protruding 30 mm was fixed to an automatic winder, and the piece was peeled off at a peel angle of 150° and a peeling rate of 10 m/minute. In this operation, the electrical potential generated on the surface of the polarizing plate was measured using a potential meter (KSD-0103 manufactured by KASUGA ELECTRIC WORKS LTD.) fixed at a predetermined position. The distance between the sample and the potential meter was 100 mm during the measurement on the surface of the acrylic plate. The measurement was performed in an environment at 23° C. and 24±2% RH.

The pressure-sensitive adhesive sheet of the invention preferably has a peeling electrification voltage (absolute value) of 1.3 kV or less, more preferably 1.0 kV or less. If the peeling electrification voltage exceeds 1.3 kV, the pressure-sensitive adhesive sheet being peeled off can easily adsorb dust, which is not preferred.

### (2) Ability to Prevent Increase in Peel Strength (Initial Peel Strength)

The prepared pressure-sensitive adhesive sheet was cut into a piece with a size of 25 mm in width and 100 mm in length, and the separator was peeled off. Using a laminator (Compact Laminator manufactured by TESTER SANGYO CO., LTD.), the resulting piece was then laminated onto a polarizing plate (SEG1425DU manufactured by NITTO DENKO CORPORATION, 70 mm wide, 100 mm long) under the conditions of 0.25 MPa and 0.3 m/minute to form an evaluation sample.

After the lamination, the sample was allowed to stand in an environment at 23° C. and 50% RH for 30 minutes and then measured for peel strength (adhesive strength) (N/25 mm) at a peel angle of 180° and a peeling rate of 30 m/minute using a universal tensile tester. The measured peel strength was called the “initial peel strength.” The measurement was performed in an environment at 23° C. and 50% RH.

The pressure-sensitive adhesive sheet of the invention preferably has an initial peel strength of 0.1 to 1.3 N/25 mm, more preferably 0.2 to 1.2 N/25 mm. The pressure-sensitive adhesive sheet with a peel strength of 1.4 N/25 mm or less is preferable in that it can be easily peeled off to make productivity or handleability higher in the process of manufacturing polarizing plates or liquid crystal display devices. The pressure-sensitive adhesive sheet with a peel strength of 0.1 N/25 mm or more is preferable in that it can be prevented from lifting or peeling in manufacturing processes and can sufficiently function as a surface protecting sheet.

(Peel Strength after Bonding and Storing at 40° C. for 1 Week (Peel Strength Over Time))

The sample obtained by laminating the pressure-sensitive adhesive sheet and the polarizing plate was stored in an environment at 40° C. for 1 week and then allowed to stand in an environment at 23° C. and 50% RH for 2 hours. The sample was then subjected to a 180° peel test at a peeling rate of 30 m/minute, in which the peel strength (adhesive strength) (N/25 mm) between the pressure-sensitive adhesive sheet and the polarizing plate was measured and called the “peel strength over time.”

If the difference between the peel strength over time and the initial peel strength [(the peel strength over time)−(the initial peel strength)] is less than 0.5 N/25 mm, the pressure-sensitive adhesive sheet can be judged to be superior in the ability to prevent an increase in peel strength (adhesive strength). The difference between the peel strength over time and the initial peel strength [(the peel strength over time)−(the initial peel strength)] of the pressure-sensitive adhesive sheet of the invention is preferably less than 0.5 N/25 mm, more preferably 0.0 to 0.2 N/25 mm. If the difference is 0.5 N/25 mm or more, the ability to prevent an increase in peel strength (adhesive strength) can be poor, so that the workability of removal of the pressure-sensitive adhesive sheet may degrade in some cases.

### (3) Less-Staining Properties (White Staining) [Humidity Test]

Using a laminator (Compact Laminator manufactured by TESTER SANGYO CO., LTD.), the pressure-sensitive adhesive sheet (sample size: 25 mm wide and 100 mm long) obtained in each of the examples and the comparative examples was laminated onto a polarizing plate (SEG1425DU (trade name) manufactured by NITTO DENKO CORPORATION, size: 70 mm wide and 120 mm long) under the conditions of 0.25 MPa and 0.3 m/minute.

The laminate composed of the polarizing plate and the pressure-sensitive adhesive sheet bonded thereto was allowed to stand at 80° C. for 4 hours, and then the pressure-sensitive adhesive sheet was peeled off. The polarizing plate obtained by peeling off the pressure-sensitive adhesive sheet was then allowed to stand in a humidified environment (23° C., 90% RH) for 12 hours. The surface of the polarizing plate was then visually observed and evaluated for less-staining properties according to the criteria shown below. If white staining occurs on the polarizing plate as the adherend under the humidified conditions (high-humidity conditions) after the bonding and peeling off of the pressure-sensitive adhesive sheet, the less-staining properties of the pressure-sensitive adhesive sheet can be judged to be not enough for optical member surface-protecting film applications.

Good level of less-staining properties (o): No change was observed in the part where the pressure-sensitive adhesive sheet had been bonded and in the part where it had not been bonded.

Poor level of less-staining properties (x): White staining was observed in the part where the pressure-sensitive adhesive sheet had been bonded.

TABLE 3

| | |
|---|---|
| Example | Comparative Example |

| Components and evaluation results | | | 2-1 | 2-2 | 2-3 | 2-4 | 2-5 | 2-1 | 2-2 | 2-3 |
|---|---|---|---|---|---|---|---|---|---|---|
| Acrylic emulsion | Raw material | 2EHA | 96 | 96 | 98 | 92 | 96 | 96 | 96 | 96 |
| polymer | monomers | AA | 4 | 4 | 2 | 4 | 4 | 4 | 4 | 4 |
| (parts by weight) | | MMA | | | | 4 | | | | |
| | Emulsifier | HS-1025 | 3 | 3 | 3 | 3 | 3 | 3 | 3 | 3 |
| Removable | Acrylic emulsion polymer | | 100 | 100 | 100 | 100 | 100 | 100 | 100 | 100 |
| water-dispersible | Non-water-soluble | TETRAD-C | 2 | 2.5 | 2 | 2.5 | | 2.5 | | 8.8 |
| acrylic pressure- | crosslinking agent | TETRAD-X | | | | | 3 | | | |
| sensitive adhesive | Water-soluble | EX-512 | | | | | | | 4.6 | |
| composition | crosslinking agent | | | | | | | | | |
| (parts by weight) | Antistatic agent | LiCF₃SO₃ | 1 | 1 | 1 | 1 | | | | |
| | | SF-106 | | | | | | | | |
| (Number of moles of functional group capable of | | | 0.3 | 0.4 | 0.3 | 0.4 | 0.5 | 0.4 | 0.5 | 1.5 |
| reacting with carboxyl group)/(number of moles of | | | | | | | | | | |
| carboxyl group) (molar ratio) | | | | | | | | | | |
| Evaluation | Peeling electrification voltage (kV) | | 0.9 | 0.8 | 0.7 | 0.9 | 0.8 | 2.9 | 2.3 | 1.8 |
| results | Peel strength | Initial peel | 0.7 | 0.6 | 0.7 | 0.6 | 0.5 | 0.7 | 1.5 | Not |
| | (N/25 mm) to DU | strength | | | | | | | | evaluable |
| | | Peel strength | 0.7 | 0.6 | 0.8 | 0.7 | 0.5 | 0.8 | 1.4 | Not |
| | | over time | | | | | | | | evaluable |

| | | | | | | | | |
|---|---|---|---|---|---|---|---|---|
| Less-staining properties | ◯ | ◯ | ◯ | ◯ | ◯ | ◯ | X | ◯ |

| | | | Comparative | | |
|---|---|---|---|---|---|
| | | | Example | | |
| Components and evaluation results | | | 2-4 | 2-5 | 2-6 |
| Acrylic emulsion | Raw material | 2EHA | 96 | 99.6 | 85 |
| polymer | monomers | AA | 4 | 0.4 | 15 |
| (parts by weight) | | MMA | | | |
| | Emulsifier | HS-1025 | 3 | 3 | 3 |
| Removable | Acrylic emulsion polymer | | 100 | 100 | Pressure-sensitive adhesive sheet was not able |
| water-dispersible | Non-water-soluble | TETRAD-C | 2.5 | 0.3 | to be prepared due to formation of aggregate |
| acrylic pressure- | crosslinking agent | TETRAD-X | | | during preparation of acrylic emulsion polymer. |
| sensitive adhesive | Water-soluble | EX-512 | | | |
| composition | crosslinking agent | | | | |
| (parts by weight) | Antistatic agent | LiCF₃SO₃ | | 1 | |
| | | SF-106 | 1 | | |
| (Number of moles of functional group capable of | | | 0.4 | 0.5 | |
| reacting with carboxyl group)/(number of moles of | | | | | |
| carboxyl group) (molar ratio) | | | | | |
| Evaluation | Peeling electrification voltage (kV) | | 2.6 | 2.7 | |
| results | Peel strength | Initial peel | 0.5 | 4.2 | |
| | (N/25 mm) to DU | strength | | | |
| | | Peel strength | 0.5 | 6.1 | |
| | | over time | | | |

| | | |
|---|---|---|
| Less-staining properties | X | X |

In Table 3, the weight of the solid is shown with respect to each component. The following abbreviations are used in Table 3.

2EHA: 2-ethylhexyl acrylate

MMA: Methyl methacrylate

AA: Acrylic acid

HS-1025: AQUALON HS-1025 (trade name) manufactured by Dai-ichi Kogyo Seiyaku Co., Ltd. (a reactive nonionic-anionic emulsifier)

TETRAD-C: TETRAD-C(trade name) manufactured by MITSUBISHI GAS CHEMICAL COMPANY, INC. (1,3-bis(N,N-diglycidylaminomethyl)cyclohexane, 110 in epoxy equivalent, 4 in the number of functional groups) (a non-water-soluble crosslinking agent)

TETRAD-X: TETRAD-X (trade name) manufactured by MITSUBISHI GAS CHEMICAL COMPANY, INC. (1,3-bis(N,N-diglycidylaminomethyl)benzene, 100 in epoxy equivalent, 4 in the number of functional groups) (a non-water-soluble crosslinking agent)

EX-512: Denacol EX-512 (trade name) manufactured by Nagase ChemteX Corporation (polyglycerol polyglycidyl ether, 168 in epoxy equivalent, 4 in the number of functional groups) (a water-soluble crosslinking agent)

LiCF₃SO₃: Lithium trifluoromethanesulfonate (in the form of a 50% by weight aqueous solution), which is an alkali metal salt containing fluorine (an antistatic agent).

SF-106: ADEKA MINE SF-106 (trade name) manufactured by ADEKA CORPORATION (dimethyldialkyloxyethyleneammonium chloride (a non-alkali-metal salt), 80% by weight in solid content) (an antistatic agent)

From the evaluation results in Table 3, it has been found that in all the examples (Examples 2-1 to 2-5), the resulting pressure-sensitive adhesive layers (pressure-sensitive adhesive sheets) are superior not only in antistatic properties, removability, and the ability to prevent an increase in peel strength (adhesive strength) over time, but also in less-staining properties on adherends, especially, the ability to prevent white staining on adherends in a high-humidity environment (the ability to prevent white staining).

On the other hand, it has been found that in Comparative Example 2-1 where the alkali metal salt as an antistatic agent was not added, the peeling electrification voltage was very high, and antistatic properties were not obtained. In Comparative Example 2-2 where neither the antistatic agent nor the non-water-soluble crosslinking agent was added, but a water-soluble crosslinking agent was added as an alternate, not only the antistatic properties were poor, but also the initial peel strength and the less-staining properties were inferior. In Comparative Example 2-3 where the antistatic agent was not added, not only the antistatic properties were poor, but also the pressure-sensitive adhesive layer had a poor appearance, and the peel strength itself was not able to be measured. In Comparative Example 2-4 where a non-alkali metal salt was used as the antistatic agent, antistatic properties were not obtained, and the less-staining properties were inferior. In Comparative Example 2-5 where the content of the alkyl(meth)acrylate was relatively high while the content of acrylic acid (a carboxyl group-containing unsaturated monomer) was relatively low, the initial peel strength was relatively high, the peel strength over time was also very high, so that the ability to prevent an increase in peel strength (adhesive strength) was inferior, and the less-staining properties were also inferior. In Comparative Example 2-5, the antistatic properties were also poor, even though an antistatic agent was added. In Comparative Example 2-6 where the content of acrylic acid (a carboxyl group-containing unsaturated monomer) was relatively high, the pressure-sensitive adhesive sheet was not able to be prepared due to the formation of an aggregate in the process of preparing the acrylic emulsion polymer.

### DESCRIPTION OF REFERENCE SIGNS

1 Potential meter
2 Pressure-sensitive adhesive sheet
3 Polarizing plate
4 Acrylic plate
5 Sample mount

1. A removable water-dispersible acrylic pressure-sensitive adhesive composition, comprising:
an acrylic emulsion polymer comprising units derived from raw material monomers including (i) 70 to 99.5% by weight of an alkyl(meth)acrylate and (ii) 0.5 to 10% by weight of a carboxyl group-containing unsaturated monomer;
a non-water-soluble crosslinking agent; and
an ionic compound.

2. The removable water-dispersible acrylic pressure-sensitive adhesive composition according to claim 1, wherein the ionic compound is an ionic liquid and/or an alkali metal salt.

3. The removable water-dispersible acrylic pressure-sensitive adhesive composition according to claim 2, wherein the ionic liquid contains at least one cation selected from the group consisting of cations represented by formulae (A) to (E): 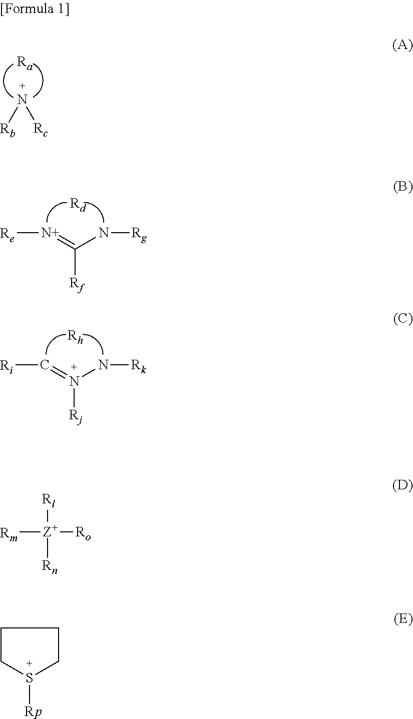
in formula (A), Rₐ represents a hydrocarbon group of 4 to 20 carbon atoms, part of the hydrocarbon group may be a heteroatom-substituted functional group, R_{b} and R_{c} are the same or different and each represent hydrogen or a hydrocarbon group of 1 to 16 carbon atoms, and part of the hydrocarbon group may be a heteroatom-substituted functional group, provided that when the nitrogen atom has a double bond, R_{c} is absent,
in formula (B), R_{d} represents a hydrocarbon group of 2 to 20 carbon atoms, part of the hydrocarbon group may be a heteroatom-substituted functional group, Rₑ, R_{f}, and R_{g} are the same or different and each represent hydrogen or a hydrocarbon group of 1 to 16 carbon atoms, and part of the hydrocarbon group may be a heteroatom-substituted functional group,
in formula (C), Rₕ represents a hydrocarbon group of 2 to 20 carbon atoms, part of the hydrocarbon group may be a heteroatom-substituted functional group, Rᵢ, Rⱼ, and Rₖ are the same or different and each represent hydrogen or a hydrocarbon group of 1 to 16 carbon atoms, and part of the hydrocarbon group may be a heteroatom-substituted functional group,
in formula (D), Z represents a nitrogen, sulfur, or phosphorus atom, Rₗ, Rₘ, Rₙ, and Rₒ are the same or different and each represent a hydrocarbon group of 1 to 20 carbon atoms, and part of the hydrocarbon group may be a heteroatom-substituted functional group, provided that when Z is a sulfur atom, Rₒ is absent, and
in formula (E), Rₚ represents a hydrocarbon group of 1 to 18 carbon atoms, and part of the hydrocarbon group may be a heteroatom-substituted functional group.

4. The removable water-dispersible acrylic pressure-sensitive adhesive composition according to claim 2, wherein the ionic liquid contains a cation of at least one selected from the group consisting of an imidazolium-containing salt type, a pyridinium-containing salt type, a morpholinium-containing salt type, a pyrrolidinium-containing salt type, a piperidinium-containing salt type, an ammonium-containing salt type, a phosphonium-containing salt type, and a sulfonium-containing salt type.

5. The removable water-dispersible acrylic pressure-sensitive adhesive composition according to claim 2, wherein the ionic liquid contains at least one cation selected from the group consisting of cations represented by formulae (a) to (d): 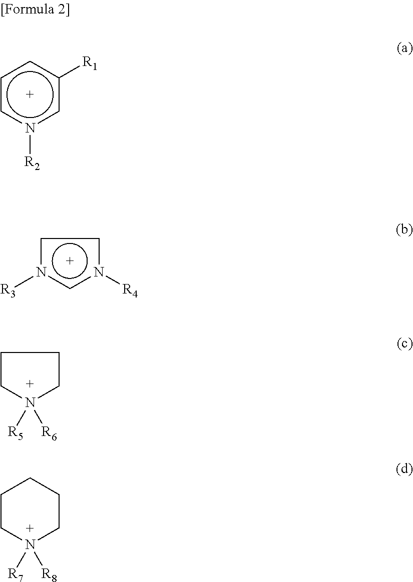
in formula (a), R₁ represents hydrogen or a hydrocarbon group of 1 to 3 carbon atoms, and R₂ represents hydrogen or a hydrocarbon group of 1 to 7 carbon atoms,
in formula (b), R₃ represents hydrogen or a hydrocarbon group of 1 to 3 carbon atoms, and R₄ represents hydrogen or a hydrocarbon group of 1 to 7 carbon atoms,
in formula (c), R₅ represents hydrogen or a hydrocarbon group of 1 to 3 carbon atoms, and R₆ represents hydrogen or a hydrocarbon group of 1 to 7 carbon atoms, and
in formula (d), R₇ represents hydrogen or a hydrocarbon group of 1 to 3 carbon atoms, and R₈ represents hydrogen or a hydrocarbon group of 1 to 7 carbon atoms.

6. The removable water-dispersible acrylic, acryl-based, pressure-sensitive adhesive composition according to claim 2, which contains 4.9 parts by weight or less of the ionic liquid based on 100 parts by weight (on a solid basis) of the acrylic emulsion polymer.

7. The removable water-dispersible acrylic pressure-sensitive adhesive composition according to claim 2, wherein the alkali metal salt has a fluorine-containing anion.

8. The removable water-dispersible acrylic pressure-sensitive adhesive composition according to claim 2 or 7, wherein the alkali metal salt is a lithium salt.

9. The removable water-dispersible acrylic pressure-sensitive adhesive composition according to claim 2, which contains 3 parts by weight or less of the alkali metal salt based on 100 parts by weight of the solid of the acrylic emulsion polymer.

10. The removable water-dispersible acrylic pressure-sensitive adhesive composition according to claim 1, wherein the acrylic emulsion polymer is a product of polymerization with a reactive emulsifier containing a radically-polymerizable functional group in its molecule.

11. The removable water-dispersible acrylic pressure-sensitive adhesive composition according to claim 1, wherein the non-water-soluble crosslinking agent has 0.2 to 1.3 moles of a functional group capable of reacting with a carboxyl group per mole of the carboxyl group of the carboxyl group-containing unsaturated monomer (ii).

12. A pressure-sensitive adhesive sheet, comprising:
a substrate; and
a pressure-sensitive adhesive layer formed on at least one side of the substrate and made from the removable water-dispersible acrylic, acryl-based, pressure-sensitive adhesive composition according to claim 1.

13. The pressure-sensitive adhesive sheet according to claim 12, which is a surface protecting film for use on an optical member.

14. An optical member comprising the pressure-sensitive adhesive sheet according to claim 13 as a bonded component.
